(19) United States
(12) Patent Application Publication
(10) Pub. No.: US 2025/0390895 A1
(43) Pub. Date: Dec. 25, 2025

(54) ATTENTION-BASED DATA-DRIVEN ATTRIBUTION

(71) Applicant: Microsoft Technology Licensing, LLC, Redmond, WA (US)

(72) Inventors: John Bencina, Pinole, CA (US); Erkut Aykutlug, Riverside, CA (US); Shao Tang, Cupertino, CA (US)

(73) Assignee: Microsoft Technology Licensing, LLC, Redmond, WA (US)

(21) Appl. No.: 18/752,058

(22) Filed: Jun. 24, 2024

(51) Int. Cl. H04L 41/16; H04L 41/14

(52) U.S. Cl. CPC G06Q 30/0201; G06N 3/045; G06Q 30/0242

(57) ABSTRACT

Embodiments are directed to a method for generating a path embedding representing a decision path comprising a set of touchpoints to obtain a defined outcome, each touchpoint comprising an electronic interaction between electronic devices, generating an attention path embedding based on the path embedding using an attention network of a machine learning model, the attention path embedding comprising a set of aggregated attention weights for the set of touchpoints in the decision path, generating a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome, and providing a recommendation for a connections networking system based on the set of touchpoint contribution values. Other embodiments are described and claimed.

### BACKGROUND

Recent advancements in technology have led to the evolution of platforms that monitor and control interactions between user accounts and computing applications of online systems. The task of overseeing access and activities of numerous user accounts across multiple computing applications, each with its unique set of permissions, is crucial yet complex. It involves analyzing user account engagement with specific applications, an important factor in managing the allocation of hardware and software resources effectively. Consequently, there is a pressing demand for reliable methods to manage interactions between accounts and applications, ensuring the availability of adequate server and network resources, such as computer memory and bandwidth, to accommodate the processing demands triggered by application usage.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a network environment in accordance with one embodiment.

FIG. 2 illustrates logic diagram in accordance with one embodiment.

FIG. 3 illustrates artificial intelligence (AI) system in accordance with one embodiment.

FIG. 4 illustrates a machine learning (ML) model in accordance with one embodiment.

FIG. 5 illustrates a logic diagram in accordance with one embodiment.

FIG. 6 illustrates a positional encoding layer in accordance with one embodiment.

FIG. 7 illustrates an attention layer in accordance with one embodiment.

FIG. 8 illustrates an attention layer in accordance with one embodiment.

FIG. 9 illustrates a concatenation layer in accordance with one embodiment.

FIG. 10 illustrates a calibration layer in accordance with one embodiment.

FIG. 11 illustrates a logic diagram in accordance with one embodiment.

FIG. 12 illustrates a logic diagram in accordance with one embodiment.

FIG. 13 illustrates a logic flow in accordance with one embodiment.

FIG. 14 illustrates a system in accordance with one embodiment.

FIG. 15 illustrates an apparatus in accordance with one embodiment.

FIG. 16 illustrates an artificial intelligence architecture in accordance with one embodiment.

FIG. 17 illustrates an artificial neural network in accordance with one embodiment.

FIG. 18 illustrates a computer-readable storage medium in accordance with one embodiment.

FIG. 19 illustrates a computing architecture in accordance with one embodiment.

FIG. 20 illustrates a communications architecture in accordance with one embodiment.

### DETAILED DESCRIPTION

### Overview

An electronic interaction involves an exchange of information between electronic devices over a network. For example, a client device sends a request for information to a server device, and the server device sends the information to the client device, and vice-versa. This exchange of information may occur over multiple sessions separated in time. In some cases, a series of electronic interactions are connected together as a series of operations leading to a final defined outcome. Non-limiting examples of a defined outcome include failure of a physical part in a device or system, detection of fraudulent data or transactions, detection of a cybersecurity event, completion of a search session, discovery of media content, resolution of a technical problem, subscribing to a computing application, or conducting an electronic commerce (e-commerce transaction), among other types of defined outcomes. A particular example of a defined outcome is a purchase of a product or service through an e-commerce transaction on a website hosted by the server device. In this example, a user operates the client device to engage in a series of electronic interactions with the server device for purposes of exploring content information about the product or service over multiple sessions spanning a given time period, such as days, weeks, or months. Eventually, the user decides to purchase the product or service. The user operates the client device to complete the e-commerce transaction to purchase the product or service.

Each electronic transaction consumes a certain amount of technical resources, such as network bandwidth, processing power, memory, storage, energy, network infrastructure, and security resources. For example, both the client device and the server device consume network bandwidth, which is an amount of data that can be transmitted in a specific time frame. Both server and client devices use processing power to execute the transaction, such as servers for processing requests and executing back-end logic, and client devices for running a user interface and handling user input. Further, temporary memory resources are used on the server to handle the session data, process requests, and sometimes cache data for faster access. Client devices also use memory to run the application or browser, rendering the interface, and managing local operations. Servers use permanent storage to store transaction data, logs, and other related information. Client devices use local storage for saving application data relevant to the transaction. Both client and server devices require electrical energy to power the hardware during the transaction. Routers, switches, and other networking equipment facilitate the data transfer between client and server consume resources and require maintenance. Encryption, authentication, and other security measures consume additional processing power and can increase the data payload size due to security tokens and encrypted data, thus also consuming more bandwidth. Consequently, understanding and managing the consumption of these resources is essential for optimizing electronic transactions, improving efficiency, reducing costs, and ensuring scalability.

Conventional techniques for managing technical resources supporting electronic interactions face several technical challenges that impact their effectiveness. For example, when a client device engages in a series of electronic interactions with a server device to purchase a product or service, the server device hosts content objects associated with the product or service. As a user engages in a first electronic interaction to consume a first content object, the user decides whether to initiate a second electronic interaction to consume a second content object. This process continues over a set of electronic interactions, sometimes over multiple sessions, until the user decides to purchase the product or service or terminate investigation of the product or service. The server device, or collection of server devices in a data center, handles many electronic interactions from multiple client devices simultaneously. An increase in electronic interactions increases server loads over time. When server loads exceed predetermined limits, the server device or entire data center may become congested or even non-operational. However, conventional systems fail to properly analyze the electronic interactions to determine how to reduce server loads. For example, a number of electronic interactions in a series of electronic interactions are null interactions suitable for removable from a future series of electronic interactions. A null interaction refers to an interaction that does not result in any change to a defined outcome. It is an interaction that is initiated but concludes without having any effect on the defined outcome. Non-limiting examples of null transactions include unnecessary interactions for a defined outcome, fraudulent interactions by malicious software (malware), spammed interactions from robots (bots), duplicate interactions for a same content object, and other types of null interactions.

Embodiments provide a technical solution to these and other technical challenges in managing technical resources for electronic interactions. Embodiments are generally directed to an AI system designed to assist in managing electronic interactions between electronic devices. An electronic interaction represents an exchange of information between the electronic devices, such as content information hosted by one or both devices, for example. Some embodiments are particularly directed to an AI system to manage a series of electronic exchanges, over one or more sessions, separated in time. In one embodiment, for example, the AI system utilizes a machine learning (ML) model to receive as input electronic interaction data (EID) representing a series of electronic interactions between a client device and a server device to obtain a defined outcome. The ML model analyzes the exchange data to identify patterns. One example of a pattern represents a relationship between an electronic interaction and the defined outcome. The pattern indicates a level of contribution made by each electronic interaction in the series of electronic interactions to the defined outcome. The ML model then outputs a metric representing each level of contribution, from a total available contribution, of a corresponding electronic interaction.

In one embodiment, for example, the metric represents an allocation of a portion of a total available credit for a series of electronic interactions, referred to herein as “touchpoint contribution value.” In this example, the touchpoint contribution value is a value that represents an assignment or allocation of a specific percentage of a total amount of available credit to each electronic interaction based on a detected pattern. For example, the touchpoint contribution represents an assignment of a certain percentage of a total available credit (e.g., 100%) based on an analysis of the detected pattern, such that the sum of all individual touchpoint contribution percentages equals the total available credit (e.g., 100%). This ensures that each electronic interaction receives a share of the total available credit that represents a level of contribution the electronic interaction to a defined outcome. In various embodiments, touchpoint data representing touchpoints can be stored in a local touchpoint database for an electronic device or a remote touchpoint database accessible via a network, such as a touchpoint database for a connections system, a touchpoint database for a client system, a touchpoint database for a third-party system, and so forth. Embodiments are not limited in this context.

The AI system uses the metric to optimize resources for future electronic interactions. For example, the AI system uses the metric to allocate technical resources for future electronic interactions. The AI system uses the metric to optimize future electronic transactions, improving efficiency, reducing costs, and ensuring scalability. For instance, the AI system uses the metric to update content information hosted by one or both devices so that the electronic content information is more engaging for users. The AI system performs targeted updates to content information based on the touchpoint contribution, with content information associated with electronic interactions with higher touchpoint contributions receiving a higher level of attention. This process is repeated in an iterative process for each series of electronic interactions associated with a particular defined outcome. Other embodiments are described and claimed.

Embodiments implement various technical solutions to technical challenges resulting in significant technical advantages. For example, the AI system reduces or eliminates null interactions from a series of electronic interactions performed to obtain a defined outcome. The AI system utilizes an ML model that generates a metric representing an amount of contribution an electronic interaction in a series of electronic interactions makes to a defined outcome. The AI system utilizes the metric to focus updates to content information associated with the series of electronic interactions. This process is repeated in an iterative process, with each iteration providing a higher level of attention to update and refine content information that tends to contribute more to the defined outcome and a lower level of attention to content information that tends to contribute less to the defined outcome. The iterative process reduces a number of electronic interactions in future series of electronic interactions to obtain the defined outcome over time. For example, this process reduces or eliminates null interactions with content objects that have low contribution levels to the defined outcome, or in some cases, do not contribute to the defined outcome at all. The reduced number of electronic interactions conserves scarce and valuable technical resources consumed by the client device and the server device in future electronic exchanges. In another example, the AI system may use an ML model for planned device or system maintenance by determining which measurement event, in a time series of measures of components of a physical device, is the one contributing the most to failure of the physical device so as to enable that component to be replaced in a timely manner. The AI system may trigger an action in the data center to mitigate and/or prevent future instances of events corresponding to the selected event data item. In another example, the AI system may use an ML model for fraud detection and/or enhanced security by determining which measurement event, in a time series of measures of electronic interactions comprising probing attempts on a network (e.g., ports, devices, connections, etc.), is the one contributing the most to detection or prevention of a cybersecurity attack so as to enable a cybersecurity measures to be deployed in a timely manner. The AI system may serve other technical purposes as well. Embodiments are not limited to these examples.

Any of the above embodiments may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### DETAILED EMBODIMENT

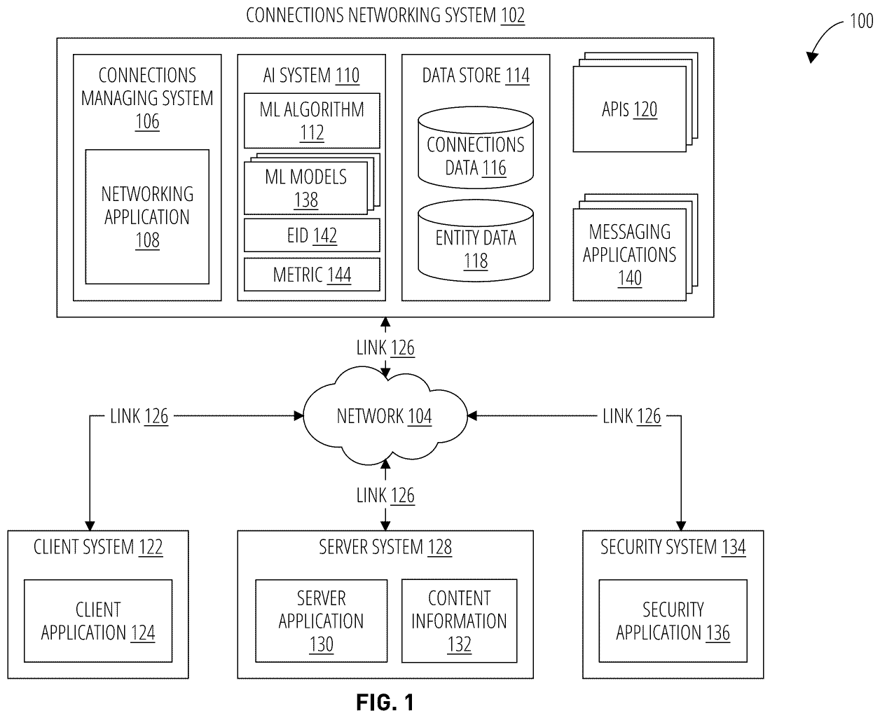

FIG. 1 illustrates an example network environment 100 associated with a connections networking system 102. Network environment 100 includes a connections networking system 102 and one or more client systems 122 connected to each other by a network 104.

This disclosure contemplates any suitable network 104. As an example and not by way of limitation, one or more portions of a network 104 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 104 may include one or more networks 104.

Links 126 may connect each client system 122 to the connections networking system 102 via the network 104. This disclosure contemplates any suitable link 126. In particular embodiments, one or more links 126 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 126 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 126, or a combination of two or more such links 126. Links 126 need not necessarily be the same throughout a network environment 100. One or more first links 126 may differ in one or more respects from one or more second links 126.

In particular embodiments, a client system 122 may be an electronic device including hardware, software, or embedded logic components or a combination of two or more such components and capable of carrying out the appropriate functionalities implemented or supported by a client system 122. As an example and not by way of limitation, a client system 122 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client systems 122. A client system 122 may enable a network user at a client system 122 to access a network 104. A client system 122 may enable its user to communicate with other users at other client systems 122, such as via messaging applications 140.

In particular embodiments, a client system 122 may include a client application 124, which may be a web browser, and may have one or more add-ons, plug-ins, or other extensions. A user at a client system 122 may enter a Uniform Resource Locator (URL) or other address directing a web browser to a particular server such as a server or server data center for a connections managing system 106 and/or an AI system 110, and the web browser may generate a Hyper Text Transfer Protocol (HTTP) request and communicate the HTTP request to the server. The server may accept the HTTP request and communicate to a client system 122 one or more Hyper Text Markup Language (HTML) files responsive to the HTTP request. The client system 122 may render a web interface (e.g. a webpage) based on the HTML files from the server for presentation via an electronic display of the client system 122 to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 124 may be an application operable to provide various computing functionalities, services, and/or resources, and to send data to and receive data from the other entities of the network 104, such as the connections networking system 102 and/or the AI system 110. For example, the client application 124 may be a connections networking application, a messaging application for messaging with users of a messaging network/system, a web browser application, an internet searching application, and so forth.

In particular embodiments, the client application 124 may be storable in a memory and executable by a processor of the client system 122 to render user interfaces, receive user input, send data to and receive data from the connections networking system 102. The client application 124 may generate and present user interfaces to a user via a display of the client system 122. For example, the client application 124 may generate and present user interfaces based at least in part on information received from the server system 128, the connections networking system 102, and/or the AI system 110 via the network 104.

In particular embodiments, a server system 128 may be an electronic device including hardware, software, or embedded logic components or a combination of two or more such components and capable of carrying out the appropriate functionalities implemented or supported by a server system 128. As an example and not by way of limitation, a server system 128 may include a computer system such as a server system comprising multiple server devices organized as a data center or cloud-computing center. This disclosure contemplates any suitable server system 128. A server system 128 may be accessed by a network user at a client system 122 via the network 104. A client system 122 may enable its user to communicate with other users at the server system 128, such as via messaging applications 140.

In particular embodiments, a server system 128 may include a server application 130, which may be a web server to server content information 132 to the client application 124 of the client system 122. The server system 128 may accept an HTTP request and communicate to a client system 122 one or more HTML files responsive to the HTTP request. The server system 128 may send HTML files representing a webpage with content information 132 for presentation via an electronic display of the client system 122 to the user.

In particular embodiments, the server application 130 may be an application operable to provide various computing functionalities, services, and/or resources, and to send data to and receive data from the other entities of the network 104, such as the client system 122, the connections networking system 102, and/or the AI system 110 of the connections networking system 102. For example, the server application 130 may be an e-commerce application, a content application, an advertisement application, a web interface, a messaging application, a video application, a webpage, and so forth.

In particular embodiments, a security system 134 may be an electronic device including hardware, software, or embedded logic components or a combination of two or more such components and capable of carrying out the appropriate functionalities implemented or supported by the security system 134. The security system 134 is a network security system that encompasses a suite of technologies, policies, and practices designed to protect the integrity, confidentiality, and availability of data within the network environment 100 from unauthorized access, attacks, and other security threats. The security system 134 comprises a security application 136 with components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security system 134 implements security practices to ensure a robust defense against a wide array of cyber threats, safeguarding organizational assets and maintaining trust with stakeholders.

In particular embodiments, the connections networking system 102 may be a network-addressable computing system that can host a connections network. The connections networking system 102 may generate, store, receive, and send connections networking data, such as, for example, user-profile data, concept-profile data, connection-graph information, or other suitable data related to the online connection network. The connections networking system 102 may be accessed by the other components of network environment 100 either directly or via a network 104. As an example and not by way of limitation, a client system 122 may access the connections networking system 102 using the client application 124, which may be a web browser or a native application associated with the connections networking system 102 (e.g., a mobile connections networking application, another suitable application, or any combination thereof) either directly or via a network 104.

In particular embodiments, the connections networking system 102 may include a connections managing system 106. The connections managing system 106 may be a server application hosted on a computing server device for managing the online connections network hosted on the connections networking system 102. The connections managing system 106 may comprise one or more physical servers or virtual servers hosting one or more networking applications 108. The servers may comprise a unitary server or a distributed server spanning multiple computers or multiple data centers. In particular embodiments, the connections managing system 106 may include hardware, software, or embedded logic components or a combination of two or more such components for carrying out the appropriate functionalities implemented or supported by connections managing system 106. Although the connections managing system 106 is shown with a single networking application 108, it should be noted that this is not by any way limiting and this disclosure contemplates any number of networking applications 108.

In particular embodiments, the connections networking system 102 may include a data store 114. The data store 114 may be used to store various types of information. In particular embodiments, the information stored in the data store 114 may be organized according to specific data structures. In particular embodiments, the data store 114 may be a relational, columnar, correlation, or other suitable database. Although this disclosure describes or illustrates particular types of databases, this disclosure contemplates any suitable types of databases. Particular embodiments may provide interfaces that enable a client system 122 or a connections networking system 102 to manage, retrieve, modify, add, or delete, the information stored in the data store 114.

In particular embodiments, the connections networking system 102 may store connections data 116 for one or more users of the connections networking system 102. In one embodiment, for example, the connections data 116 may be organized as a connections graph in the data store 114. In particular embodiments, a connections graph may include multiple nodes, which may include multiple user nodes each corresponding to a particular user or multiple concept nodes each corresponding to a particular concept, and multiple edges connecting the nodes. The connections networking system 102 may provide users of the online connections network the ability to communicate and interact with other users. In particular embodiments, users may join the online connections network via the connections networking system 102 and then add connections (e.g., relationships) to a number of other users of the connections networking system 102 to whom they want to be connected. Herein, the term “connection” may refer to any other user of the connections networking system 102 with whom a user has formed a friendship, association, or relationship via the connections networking system 102.

In particular embodiments, the connections networking system 102 may provide users with the ability to take actions on various types of items or objects, supported by the connections networking system 102. As an example and not by way of limitation, the items and objects may include groups or connections networks to which users of the connections networking system 102 may belong, events or calendar entries in which a user might be interested, computer-based applications that a user may use, transactions that allow users to apply to job openings or post job openings via the service, interactions with advertisements that a user may perform, or other suitable items or objects. A user may interact with anything that is capable of being represented in the connections networking system 102 or by an external system of a third-party system, which is separate from the connections networking system 102 and coupled to the connections networking system 102 via a network 104.

In particular embodiments, the connections networking system 102 also includes user-generated content objects, which may enhance a user's interactions with the connections networking system 102. User-generated content may include anything a user can add, upload, send, message, or “post” to the connections networking system 102. As an example and not by way of limitation, a user communicates posts to the connections networking system 102 from a client system 122. Posts may include data such as status updates or other textual data, articles, job openings, company information, awards, location information, photos, videos, links, music or other similar data or media. Content may also be added to the connections networking system 102 by a third-party through a “communication channel,” such as a newsfeed or content stream.

In particular embodiments, the connections networking system 102 may include a variety of servers, sub-systems, programs, modules, logs, and data stores. In particular embodiments, the connections networking system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connections networking system 102 may also include suitable components such as network interfaces, security mechanisms, load balancers, failover servers, management-and-network-operations consoles, privacy software, and other suitable components, or any suitable combination thereof.

In particular embodiments, the connections networking system 102 may include one or more user-profile stores for storing user profiles. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. A connection store may be used for storing connection information about users. The connection information may indicate users who have similar or common work experience, group memberships, hobbies, educational history, or are in any way related or share common attributes. The connection information may also include user-defined connections between different users and content (both internal and external).

A web server may be used for linking the connections networking system 102 to one or more of the client systems 122 via a network 104. The web server may include a mail server or other messaging functionality for receiving and routing messages between the connections networking system 102 and one or more client systems 122. An API-request server may allow a gaming platform, a third-party system, a messaging system, and/or an AI system 110 to access information from the connections networking system 102 by calling one or more APIs 120. An action logger may be used to receive communications from a web server about a user's actions on or off the connections networking system 102. In conjunction with the action log, a third-party-content-object log may be maintained of user exposures to third-party-content objects. A notification controller may provide information regarding content objects to a client system 122. Information may be pushed to a client system 122 as notifications, or information may be pulled from a client system 122 responsive to a request received from a client system 122. Authorization servers may be used to enforce one or more privacy settings of the users of the connections networking system. A privacy setting of a user determines how particular information associated with a user can be shared. The authorization server may allow users to opt in to or opt out of having their actions logged by the connections networking system 102 or shared with other systems (e.g., a third-party system), such as, for example, by setting appropriate privacy settings. Third-party-content-object stores may be used to store content objects received from third parties, such as a third-party system. Location stores may be used for storing location information received from client systems 122 associated with users. Advertisement-pricing modules may combine connections information, the current time, location information, or other suitable information to provide relevant advertisements, in the form of notifications, to a user.

In particular embodiments, the connections networking system 102 may include an AI system 110 to manage one or more ML algorithms 112 to train and manage one or more ML models 138. Similar to the connections managing system 106, the AI system 110 may comprise one or more physical servers or virtual servers hosting one or more ML algorithms 112 and/or ML models 138. The servers may comprise a unitary server or a distributed server spanning multiple computers or multiple data centers. In particular embodiments, the AI system 110 may include hardware, software, or embedded logic components or a combination of two or more such components for carrying out the appropriate functionalities implemented or supported by AI system 110. Although the AI system 110 is shown with a single ML algorithm 112 and ML models 138, it should be noted that this is not by any way limiting and this disclosure contemplates any number of ML algorithms 112 and/or ML models 138.

The AI system 110 may be a network-addressable computing system that can host an online AI system to support operations for the connections managing system 106, such as the networking application 108, the server system 128, and/or the security system 134. For instance, the AI system 110 may monitor and collect electronic interaction data 142 for electronic interactions across the network environment 100, such as electronic interactions to access products and/or services, or content information for products and/or services, offered by the server system 128, the security system 134, and/or the connections networking system 102, via the client system 122 and the client application 124. The AI system 110 may be accessed by one or more entities of the network environment 100 either directly or via the network 104. As an example and not by way of limitation, a messaging system may access the AI system 110 by way of one or more APIs 120 (e.g., API calls). API calls may be handled by an API handler.

In particular embodiments, the AI system 110 manages electronic interactions between client computers and computing applications over a defined time period. For example, the AI system 110 manages electronic interactions between the client system 122 and the connections networking system 102, the server system 128, and/or the security system 134. Non-limiting examples of management operations performed by the AI system 110 includes collecting electronic interaction data 142 for electronic interactions, identifying past electronic interactions, predicting future electronic interactions, analyzing electronic interactions for patterns, measuring electronic interactions, evaluating contributions of electronic interactions to a defined outcome, interpolating missing data for electronic interactions, and so forth. An electronic interaction is any exchange of information between two or more electronic devices. Non-limiting examples of electronic devices include client system 122 and servers for the connections networking system 102, the server system 128, and the security system 134, among other types of electronic devices.

Some embodiments are particularly directed to AI system 110 utilizing an ML algorithm 112 to train an ML models 138. The ML algorithm 112 is an algorithm that a computer system uses to train one or more ML models 138 to analyze data in order to make predictions or decisions without explicit programming to perform the task. Non-limiting examples of ML algorithm 112 include supervised learning algorithms, unsupervised learning algorithms, semi-supervised learning algorithms, reinforcement learning algorithms, deep learning algorithms, transfer learning algorithms, and so forth.

In one embodiment, for example, the AI system 110 utilizes the ML algorithm 112 to train an ML model such as an advanced attribution model. The advanced attribution model is a machine learning model trained to quantify what impact an electronic interaction has on an observed defined outcome. The advanced attribution model is a data-driven attribution (DDA) model that uses machine learning or probabilistic approaches to estimate an appropriate amount of credit to associate with each electronic interaction. The advanced attribution model may be implemented as a multi-touch attribution (MTA) model or a media mixed modeling (MMM). MTA models operate in a bottom-up approach by modeling against granular touchpoint data. MMM models work in a top-down approach by modeling on aggregated metrics.

The advanced attribution model is trained to receive as input electronic interaction data 142 and process the electronic interaction data 142 to generate a metric 144 associated with the electronic interaction data 142. For example, the advanced attribution model analyzes electronic interaction data 142 representing a series of electronic interactions between the client system 122 and the connections networking system 102, the server system 128, or the security system 134, to identify patterns in the series of electronic interactions. In one embodiment, for example, the series of electronic interactions are in a time-based sequential order defined by a starting electronic interaction, one or more intermediate electronic interactions, and an ending electronic interaction. In this case, the series of electronic interactions comprise time-series data.

In one embodiment, for example, a time-based sequential order comprises a series of sequential electronic interactions between a client device for a user and a server device for an entity offering a product or service. Each sequential electronic interaction occurs in a point in time along a timeline measured in defined time intervals, such as days, weeks, months, etc. In this particular use case, each electronic interaction represents a “touchpoint” between the user and the entity as the user acquires information to decide to procure the product or service. A collection of touchpoints is referred to as a “decision path” since each touchpoint represents a micro-decision by the user to continue along the decision path to acquire information about the product or service until the user has sufficient information to make a final decision about the product or service. For example, a final decision includes a decision to purchase the product or service, terminate the decision path, initiate another decision path for a different product or service by the same or different entity, and so forth.

Once trained, the advanced attribution model generates a metric 144 based on a pattern in the time-based sequential order. A non-limiting example of a metric is a touchpoint contribution value representing an amount of contribution made by each electronic interaction to a defined outcome measured against an ending electronic interaction. The advanced attribution model compares the ending electronic action to a defined outcome of the time-based sequential order, and it outputs a metric representing a score for each electronic interaction in the series of electronic interactions. When the electronic interaction data represents a decision path for procurement of a product or service, the metric 144 comprises a “touchpoint contribution” representing a level of contribution made by each electronic interaction in obtaining the defined outcome. For example, when the decision path is for procurement of a product or service, the ML model generates a probability percentage representing a touchpoint contribution for each touchpoint along the decision path to a final purchase of the product or service.

In one embodiment, for example, the AI system 110 implements an advanced attribution model as a transformer model using a customized attention network. The advanced attribution model receives as input the interaction data representing a series of electronic interactions between electronic devices, and it generates one or more metrics 144 for the series of electronic interactions between the electronic devices. A non-limiting example of a metric 144 comprises a touchpoint contribution, from a total available credit, to each “touchpoint” (e.g., electronic interaction) in the decision path. The touchpoint contribution represents, for example, a contribution of a given touchpoint in the decision path to a target defined outcome (e.g., an ending electronic interaction) of the decision path. In one embodiment, for example, a target defined outcome comprises procurement of a product or service of an entity (e.g., a company).

In various embodiments, the AI system 110 is designed to generate metrics 144 representing electronic interactions between client systems 122 and computing applications, such as networking application 108, executing on one or more servers of the connections networking system 102 over a defined time period. Non-limiting examples of electronic interactions include an input device of a client system 122 accessing a networking application 108 executing on a server computer to perform an action, such as clicking on a hyperlink, generating a search query to perform a search on a search application, opening an email, selecting an advertisement, engaging in a chat message, requesting information via a messaging service, generating a prompt for a machine learning model, and other input and output (I/O) between the client system 122 and the networking application 108 executing on the server computer. A non-limiting example of a defined time period comprises a time period spanning an ordered series of electronic interactions between a client computer and a computing application, such as days, week, months, years, and so forth.

In one embodiment, for example, the AI system 110 implements an advanced attribution model to generate or output a metric 144 representing an assignment, allocation, or attribution of credits, from a total available credit, to each electronic interaction in a series of electronic interactions. The touchpoint contribution represents a probability or percentage that an electronic interaction contributed to a defined outcome. For example, assume one or more users utilize a client system 122 to perform five electronic interactions with a networking application 108 of a server device over a defined time period, such as days, weeks, or months. Further assume a starting electronic interaction comprises a product search on a website, three intermediate electronic interactions include browsing the web site, interacting with a chatbot for product support, and selecting a hyperlink for product information presented on the web site, and an ending electronic interaction comprises purchasing the product through completion of an e-commerce transaction. If the electronic interaction metric represents a portion of a total available credit of 100%, the advanced attribution model allocates a portion of the 100% to each of the five electronic interactions based on an analysis of a pattern in electronic interaction data 142. For example, assume the advanced attribution model outputs a metric 144 for each electronic interaction in the series of five electronic interactions, such as a 10% of the total touchpoint contribution to the first electronic interaction, 20% of the total conversion allocation to the second electronic interaction, 25% of the total touchpoint contribution to the third electronic interaction, 35% of the total touchpoint contribution to the fourth electronic interaction, and 10% of the total touchpoint contribution to the fifth and final electronic interaction (i.e., 10%+20%+25%+35%+10%=200%). The touchpoint contribution values represent an estimated contribution of each electronic interaction in the series of electronic interactions to the final electronic interaction. The touchpoint contributions are suitable for use by any number of downstream applications, such as reporting for internal business units, external facing business partners, vendors, and third-party entities. This approach enables better budget allocation, improved customer engagement, and enhanced overall marketing performance, leading to more informed decision-making and increased return on investment (ROI).

In one embodiment, for example, the AI system 110 utilizes an advanced attribution model that assigns, allocates, or attributes credit to various touchpoints along a decision path (e.g., series of electronic interactions). In one embodiment, for example, the AI system 110 utilizes a path interpolation model that receives as input electronic interaction data 142 from a decision path, and it computes unobserved touchpoints between or around observed touchpoints. This is particularly useful when electronic interaction data 142 is limited for a given decision path. The path interpolation model then outputs a modified decision path that provides a more comprehensive view for a customer journey. The modified decision path is then used as input to the advanced attribution model.

In one embodiment, for example, the AI system 110 implements an advanced attribution model based on a transformer model. The transformer model includes a self-attention network to generate a set of self-attention weights as a proportional factor for touchpoint contribution across various touchpoints. Specifically, the AI system 110 implements an advanced attribution model that uses multiple single-head attention structures to generate multiple sets of attention weights. The advanced attribution model then aggregates and averages the multiple sets of attention weights to increase the stability of credit assignments. By aggregating information from diverse attention heads, the multi-head attention-based approach can provide more robust and reliable attribution results. Additionally, or alternatively, the attribution model can further utilize a full transformer block with the multi-head attention structure and perform aggregation on the outputs of the transformer blocks. By aggregating information from multiple transformer blocks, the transformer approach can further provide even more robust and reliable attribution results.

In one embodiment, for example, the AI system 110 implements an advanced attribution model that uses dual position encoding and embeddings. Attention-based mechanisms are unable to natively differentiate touchpoint ordering in sequential data. The advanced attribution model combines two different techniques for effectively modeling position information for touchpoints in a decision path. First, the attribution model uses positional encodings to capture an overall ordering of a sequence from start to end. The positional encodings, however, do not necessarily capture a magnitude of time between interactions. The attribution model therefore adds positional embeddings where the model learns a unique embedding for each discrete time period (e.g., a day) to capture effects such as time differences and seasonality.

In one embodiment, for example, the AI system 110 implements an advanced attribution model that uses a uniform set of entity embeddings. Attribution weights are influenced by the interaction between various types of entities, such as marketing campaigns, users, members, advertisers, and companies. These entities have complex features which are difficult to model independently. The attribution model utilizes a large language model (LLM), trained on connections data for an online connections system, to produce uniform embedding representations. This is achieved by constructing natural language descriptions of each entity and using the LLM to generate the transformed embedding used for attribution modeling.

In one embodiment, for example, the AI system 110 utilizes a path interpolation model that receives as input electronic interaction data 142 from a decision path, and it interpolates or computes unobserved touchpoints between observed touchpoints. Due to privacy restrictions (e.g., GDPR, CCPA), the AI system does not always have access to data for certain user-level touchpoints or conversions, particularly from third-party systems. The AI system 110 utilizes a path interpolation model to perform a touchpoint imputation where decision paths are missing unobserved actions (e.g., impressions) that may or may not lead to an observable action (e.g., a click). Using statistics from internal and external aggregate level reporting, the path interpolation model performs probabilistic injection of imputed user events to fill the gaps in the data. Additionally, or alternatively, the AI system 110 performs a post-model calibration at a marketing channel level using a secondary marketing mix modeling (MMM) model. Channel weights from the MMM model are used to scale multi-touch attribution (MTA) weights such that campaigns total to the expected overall channel-level value while retaining their relative individual weights on more granular time periods. The path interpolation model then outputs a modified buyer decision path that provides a more comprehensive view for a customer journey. The modified decision path is then used as input to the advanced attribution model.

In various embodiments, the AI system 110 can use the advanced attribution model for other technical purposes as well. For instance, the AI system may use the advanced attribution model for fraud detection and/or enhanced security by determining which measurement event, in a time series of measures of components of a physical device, is the one contributing the most to failure of the physical device so as to enable that component to be replaced in a timely manner. For example, the advanced attribution model comprising a plurality of attention heads may receive as input a sequence of event data items. For each of the attention heads, the AI system 110 may read from the attention head a plurality of attention weights, one attention weight per event data item. For each event data item, the AI system 110 may aggregate the attention weights associated with the event data item. The AI system 110 may select one of the event data items using the aggregated attention weights, where the event data comprises telemetry data monitored from a data center implementing a connections networking service, and where the sequence of event data items is known to result in a security breach. The AI system 110 may trigger an action in the data center to mitigate and/or prevent future instances of events corresponding to the selected event data item. The AI system 110 may use the advanced attribution model for other technical purposes as well. Embodiments are not limited to this example.

Embodiments implement various technical solutions to existing technical problems that provide several technical advantages. As previously described, data integration and quality issues arise from fragmented data across different systems, incomplete tracking of offline interactions, and inaccuracies in data collection. Tracking and identifying users across multiple devices and platforms is also challenging due to privacy settings, cookie restrictions, and varying user login practices. Embodiment implement a path interpolation model to perform a touchpoint imputation where paths are missing unobserved actions (e.g., impressions) that may or may not lead to an observable action (e.g., a click). Using statistics from internal and external aggregate level reporting, the path interpolation model performs probabilistic injection of imputed user events to fill the gaps in the data. The path interpolation model simplifies software development, enhances reliability, and reduces error rates (e.g., reduced likelihood of data entry errors or missing data) for attribution processes. Additionally, the complexity of multi-channel interactions, overlapping touchpoints, and dynamic customer journeys complicates the accurate assignment of credit to individual touchpoints. To address this, embodiments implement an advanced attribution model that uses an average of multiple single-head attention weights to increase the stability of path-credit assignments. By aggregating information from diverse attention heads, the multi-head attention-based approach can provide more robust and reliable attribution results. This approach increases model stability and enhances reliability compared to conventional approaches that use a single head, which may be sensitive to noise or outlier data, thereby leading to model instability. Further, simplistic and assumption-based models often fail to capture the full complexity of customer journeys, leading to biased and inaccurate conclusions. Embodiments utilize dual position encodings and embeddings to model position information and capture effects like time differences and seasonality for the customer journeys, leading to unbiased and more accurate outcomes. This results in increased processing speed and reduced processor load relative to conventional techniques that need more training data and inferencing operations to arrive at the same level of performance. Finally, computational challenges, such as processing large data sets and providing real-time analysis, require significant resources and advanced analytical tools. Embodiments implement techniques to efficiently use computer and networking resources, such as reducing processor load, consuming less memory space, increasing processing speed (e.g., less processing operations required), reducing network bandwidth usage, and saving energy.

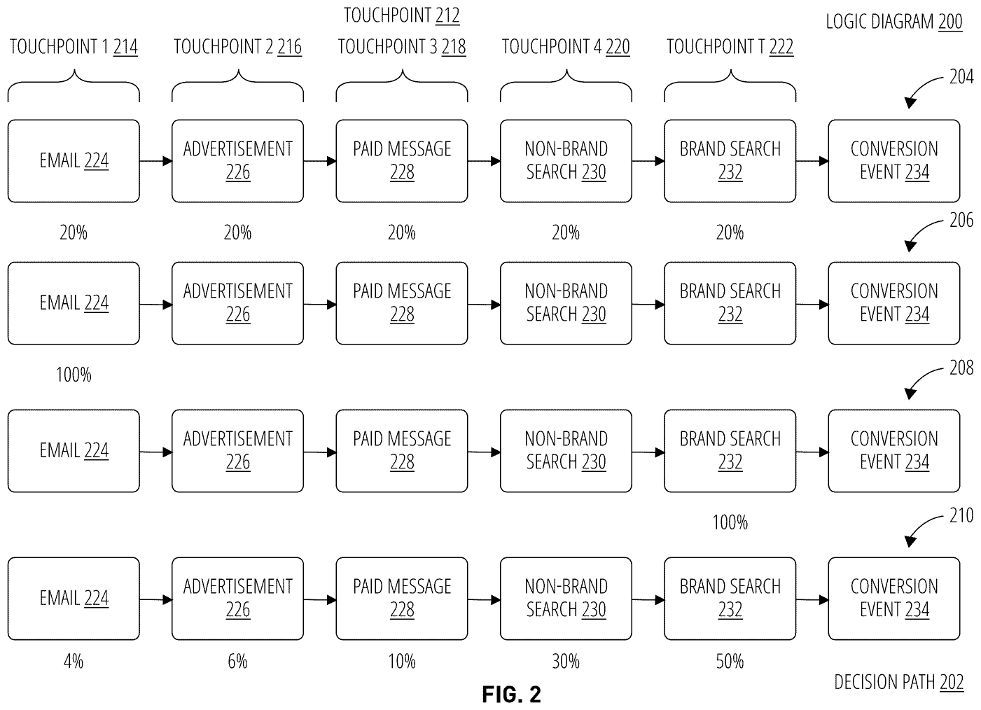

FIG. 2 illustrates a logic diagram 200. The logic diagram 200 is an example of a decision path 202 comprising a series of electronic interactions between electronic devices that are performed to obtain a defined outcome.

Specifically, the logic diagram 200 is an example of a decision path 202 to obtain a defined outcome of a purchase of a product or service offered by an entity via a server device by a user via a client device. In one embodiment, for example, a decision path 202 is associated with a pair or 2-tuple, such as <user, entity>, where the user element represents a user of the client system 122 and/or the connections networking system 102 (e.g., connections data 116), and the entity element represents an entity of the server system 128 and/or the connections networking system 102 (e.g., entity data 118). In one embodiment, for example, a decision path 202 is associated with a 3-tuple, such as <user, entity, campaign>, where the campaign element represents a marketing campaign or a marketing channel associated with the entity or a product or service provided by the entity. Embodiments are not limited to this example.

Logic diagram 200 illustrates a plurality of decision paths 202, such as decision path 1 204, decision path 2 206, decision path 3 208, and decision path P 210, where P represents any positive integer. A decision path 202 represents a series of electronic exchanges between electronic devices, such as one or more client devices and a server device, for example. Additionally, or alternatively, the series of electronic exchanges between electronic devices could occur between different client systems 122, or a client system 122 and a non-server device, in a peer-to-peer mode. The series of electronic exchanges are initiated by a user via a client system 122, or multiple different client systems 122 for the user (e.g., a smartphone, a tablet, etc.) at different times, to exchange information for purposes of obtaining a defined outcome, such as a conversion event 234. A conversion event 234 represents a conversion or a non-conversion of a user from obtaining or consuming content information about a product or service offered by an entity to completing a purchase of the product or service from the entity. When the conversion event 234 represents a non-conversion of the user, the decision path 202 may still be useful as part of a training dataset for an ML model.

A decision path 202 comprises a series of electronic interactions referred to as touchpoints 212. Touchpoints 212 include actions or interventions which are expected to have some causal effect on producing a defined outcome. A touchpoint 212 is generally any electronic interaction or communication between applications executing on one or more electronic devices. In one embodiment, for example, a touchpoint 212 comprises an electronic interaction or communication between an application executing on a client system 122 associated with a user and an application executing on a server system 128 associated with an entity throughout various stages of a procurement lifecycle for a product or service. In one embodiment, for example, a touchpoint 212 comprises an electronic interaction or communication between an application executing on a client system 122 associated with a user and a content object representing a product, service, or advertisement by an application executing on a server system 128, where the server system 128 is associated with an entity offering the product, service, or advertisement. In one embodiment, for example, a touchpoint 212 comprises an electronic interaction or communication between an application executing on a client system 122 associated with a user and a content object representing a product, a service, or advertisement by an application executing on a first server system 128, where the first server system 128 is associated with a first entity offering the product, service, or advertisement, and the content object is accessed on the first server system 128 via a second server system 128 associated with a second entity that offers access to the first server system 128 via one or more APIs. In one embodiment, for example, a touchpoint 212 comprises an electronic interaction or communication between a set of applications executing on a single electronic device, such as an electronic interaction or communication between a first application and a second application both executing on a single client system 122 associated with a user or a first application and a second application both executing on a single server system 128 associated with an entity. Embodiments are not limited to these examples.

In various embodiments, the electronic interaction or communication comprises an exchange of content information through various media channels. The touchpoints 212 occur from the initial awareness stage to post-purchase engagement and significantly influence the user's experience and perception of the brand. Examples of touchpoints 212 include advertisements, social media interactions, website visits, email marketing, customer support, and so forth. Each touchpoint 212 serves as an opportunity for the entity to engage with the user, provide valuable information, and guide them through the procurement process. Each touchpoint 212 is also referred to as a decision point, since a user decides whether to continue with a current customer journey (e.g., a current decision path 202) or start a new customer journey (e.g., a new decision path 202). Effectively managing and optimizing these touchpoints 212 is crucial for enhancing the overall user experience, increasing satisfaction, and building long-term loyalty. By understanding and addressing user needs at each touchpoint 212, entities can create personalized and seamless experiences that foster positive relationships and encourage repeat business. This strategic approach to touchpoint management helps businesses not only attract and retain customers but also turn them into brand advocates who share their positive experiences with others.

In the example of logic diagram 200, a decision path 202 comprises multiple touchpoints 212, denoted as a touchpoint 1 214, a touchpoint 2 216, a touchpoint 3 218, a touchpoint 4 220, and a touchpoint T 222, where T is any positive integer. By way of example, a touchpoint 1 214 comprises an email 224, a touchpoint 2 216 comprises an advertisement 226, a touchpoint 3 218 comprises a paid message 228, a touchpoint 4 220 comprises non-brand search 230, and a touchpoint T 222 comprises a brand search 232. A touchpoint 212 can comprise any number of different types of electronic interactions or communications. Embodiments are not limited to this example.

In some embodiments, the touchpoints 212 are sequential in order and occur at successive points in time. For example, a user operates a client device to receive and/or respond to an email 224 in a first electronic interaction, present and/or click on an advertisement 226 rendered on a graphical user interface (GUI) in a second electronic interaction, receive and/or respond to a paid message 228 from a connections system in a third electronic interaction, perform a non-brand search 230 on a website or search engine in a fourth electronic interaction, and perform a brand search 232 on a website or search engine in a fifth electronic interaction. Since the touchpoints 212 form a sequential order over time, the touchpoints 212 represent a form of time-series data. Time-series data refers to a sequence of data points collected or recorded at regular time intervals. This type of data is used to track changes over time and is characterized by its continuity and temporal ordering. Time-series data is commonly found in various fields such as finance (e.g., stock prices), meteorology (e.g., temperature readings), economics (e.g., GDP growth rates), and engineering (e.g., sensor data in machinery), among others. Analyzing time-series data allows for the identification of trends, patterns, and seasonal variations, facilitating forecasting and decision-making processes. Since the touchpoints 212 form a sequential order over time, the touchpoints 212 represent a form of time-series data that the AI system can analyze for patterns for touchpoint contribution to each touchpoint 212 in a decision path 202 for a conversion event 234.

Further, the touchpoints 212 occur in one or more sessions. A session refers to a temporary and interactive information interchange between two or more participating entities, typically a client and a server, within a networked system. During a session, the client device initiates communication requests to the server device, which then responds, allowing for the exchange of data, commands, or messages. The session maintains a continuous connection or a logical link, which can be based on session identifiers or tokens, ensuring data coherency and providing a mechanism to manage user authentication, state management, and session-specific parameters or settings. The duration of a session can be fixed or variable, ending upon completion of the transaction, through time-out mechanisms, or by explicit termination by the user or the system. Since the touchpoints 212 occur in one or more sessions over time, the touchpoints 212 represent a form of time-series data separated by sessions that the AI system can analyze for patterns for touchpoint contribution to each touchpoint 212 in a decision path 202 for a defined outcome, such as a conversion event 234, for example.

Conventional techniques attempt to analyze the time-series data using rule-based attribution (RBA) techniques. RBA techniques rely on pre-determined logic used to associate defined outcomes with touchpoints 212. These types of models are the most common class of attribution models given their simplistic implementation. The most common approach is to utilize a “last touch” attribution where events are ordered chronologically and the event closest to the outcome receives full credit. Other rules may be used like “first touch” or “equal weight” however the principle is the same. RBA techniques have the advantage of being very easy to interpret as their behavior is fully deterministic. Assuming the event data can be chronologically sequenced, identifying the last touch is a trivial exercise. The disadvantage of these techniques is that they present a biased view of attribution credit. For example, last-click models favor bottom-of-funnel (BOFU) interactions where the user is ready to convert and likely at the end of the sales funnel. Interactions like email or advertisement clicks claim full credit away from early branding campaign impressions. Some RBA techniques like equal touch distribute credit across multiple touchpoints 212, but this distribution is done without any adjustments of whether that touch actually drove any impact.

The logic diagram 200 depicts outputs from several different types of conventional algorithms designed to assign probability percentages to each touchpoint 212 representing an estimate of a level of contribution of each touchpoint 212 to the conversion event 234. For example, an equal-allocation algorithm assigns an equal probability percentage of 20% to email 224, advertisement 226, paid message 228, 230, and non-brand search 230 of the decision path 1 204. In another example, a first-touch allocation algorithm assigns a probability percentage of 200% to email 224, and a 0% to advertisement 226, paid message 228, non-brand search 230, and brand search 232 of the decision path 1 204. In yet another example, a last-touch allocation algorithm assigns a probability percentage of 0% to email 224, advertisement 226, paid message 228, and non-brand search 230, and a probability percentage of 200% to brand search 232, of decision path 2 206.

Conventional algorithms for allocating probability percentages, as depicted in decision path 1 204, decision path 2 206, and decision path 3 208, face several technical challenges that impact their effectiveness. For example, conventional algorithms often implement single-touch techniques, such as first-touch and last-touch attribution, which credit only an initial or final interaction. However, single-touch techniques are not data-driven models. Rather, they are based on a set of non-empirical assumptions. In another example, conventional systems operate on incomplete datasets. Data integration and quality issues arise from fragmented data across different systems, incomplete tracking of offline interactions, and inaccuracies in data collection. Tracking and identifying users across multiple devices and platforms is also challenging due to privacy settings, cookie restrictions, and varying user login practices. Additionally, the complexity of multi-channel interactions, overlapping touchpoints, and dynamic customer journeys complicates the accurate assignment of credit to individual touchpoints. These simplistic and assumption-based techniques often fail to capture the full complexity of customer journeys, leading to biased and inaccurate conclusions. Further, conventional systems are highly inefficient. Computational challenges, such as processing large data sets and providing real-time analysis, require significant resources and advanced analytical tools.

To overcome these and other challenges, embodiments implement the AI system 110 that utilizes various enhanced ML models 138 that are specifically designed to handle the complexities of modern customer behavior. Some of the ML models 138 are data-driven attribution (DDA) models. Unlike RBA models, DDA models do not have pre-determined logic to associate defined outcomes with touchpoints 212. Rather, DDA models use machine learning or probabilistic approaches to estimate the appropriate amount of credit to associate with each engagement. DDA models are dynamic and update as the models are trained on new data. Examples of DDA models include Multi-Touch Attribution (MTA) and Media Mixed Modeling (MMM). DDA models allow for distribution of credits across multiple touchpoints 212 and can consider additional features as part of its prediction algorithm. DDA models distribute credit amongst touchpoints 212 based on probabilities learned on training with converting and non-converting paths. DDA models have the added benefit of not requiring subjective business logic and can provide a more objective view based on observational data. MTA models operate in a bottom-up approach by modeling against granular touchpoint data. MMM models work in a top-down approach by modeling on aggregated metrics. DDA models offer more robust and objective approaches to calculating attribution.

While the exact data used will vary greatly across use cases, a general framework can still be identified which is common to attribution use cases. In attribution modeling, a defined outcome or response is preceded by one or more touchpoints 212 (e.g., electronic interactions). These touchpoints 212 can collectively be sequenced into a decision path 202. The decision path 202 and defined outcome can be associated to one or more entities. An example of these relationships is a marketing funnel where one or more advertisement exposures lead to a conversion event 234 (e.g., a purchase event). The decision path 202 comprises all of the marketing exposures received by the individual before the conversion event 234. In MTA modeling, the path level granularity is needed to perform the attribution. In instances where granular data is not available, the AI system 110 uses MMM to perform attribution on the aggregated data.

Some embodiments are particularly directed to an AI system to support attribution models for an entity. In one embodiment, for example, the AI system implements an ML model as an advanced attribution model that distributes conversion credit for user conversions across touchpoints 212. The touchpoints 212 may be explicitly or implicitly linked to users based on the available data for that marketing channel. Embodiments implement a data-driven attribution (DDA) approach utilizing both self-attention and transformer modeling. Transformers, such as large language models (LLMs), can capture complex relationships, handle sequence information, and scale to large datasets. Thus, transformers are well-suited for an attribution task. Embodiments implement an advanced attribution model that is based on a transformer utilizing a novel attention-based technique that offers a more accurate and nuanced understanding of a contribution made by each touchpoint 212 through a customer journey or decision path 202 from an initial touchpoint 212 to conversion events, such as conversion event 234, with stable results. The advanced attribution model allocates credits to each touchpoint 212 along a decision path 202. The touchpoint contributions, or attributions, are suitable for downstream applications, such as reporting for internal business units as well as reporting for external facing business partners, vendors, and third-party entities. This approach enables better budget allocation, improved customer engagement, and enhanced overall marketing performance, leading to more informed decision-making and increased return on investment (ROI).

Embodiments are particularly directed to an AI system to manage a decision path 202 comprising touchpoints 212, over one or more sessions, separated in time. In one embodiment, for example, the AI system utilizes an advanced attribution model to receive as input electronic interaction data representing a decision path 202 between a client device and a server device. The advanced attribution model analyzes the electronic interaction data to identify patterns. One example of a pattern represents a relationship between a touchpoint 212 and a defined outcome, such as a conversion event 234. The pattern indicates a level of contribution made by each touchpoint 212 in the decision path 202 to the conversion event 234. The ML model then outputs a metric representing a touchpoint contribution, such as a percentage of a total available credit (e.g., 100%), representing each level of contribution. The AI system uses the metric to update the content information hosted by one or both devices. For example, the AI system performs targeted updates to the content information based on the touchpoint contribution, with content information associated with electronic interactions with higher touchpoint contributions receiving a higher level of attention. This process is repeated in an iterative process for each series of electronic interactions associated with a particular defined outcome.

The ML model receives electronic interaction data, analyzes the electronic interaction data for patterns, and generates a metric representing a touchpoint contribution for each touchpoint 212 based on the patterns. A pattern in data refers to a set of recurring or consistent characteristics, shapes, or arrangements that can be identified within the data set. These patterns can manifest as trends, relationships, or regular occurrences in the data and can be discovered through various analytical techniques such as statistical analysis, data mining, and machine learning. Identifying patterns in data is crucial for understanding underlying structures, making predictions, informing decision-making processes, and deriving insights that can lead to actionable intelligence. The ML model analyzes the electronic interaction data to identify patterns to improve future electronic interactions. An example of a pattern is a number of times a client device requests the same or similar content information from a server device about a product or service before purchasing the product or service. The ML model identifies the pattern, and it recommends improvements to increase a probability of a future purchase of the product or service, a decrease in a number of touchpoints 212 needed to achieve conversion event 234, an increase in a recurring purchase by an existing customer, and other improvements.

By way of example, the logic diagram 200 depicts outputs from the ML model designed to assign touchpoint contributions to each touchpoint 212 representing an estimate of a level of contribution of each touchpoint 212 to the conversion event 234 in accordance with one or more embodiments. For example, in the decision path P 210, the ML model assigns a probability percentage of 4% for the email 224, a probability percentage of 6% for the advertisement 226, a probability percentage of 10% for the paid message 228, a probability percentage of 30% for the non-brand search 230, and a probability percentage of 50% for the brand search 232. As illustrated in the logic diagram 200, the ML model provides a data driven distribution across touchpoints 212 for the decision path P 210 based on an analysis of patterns in the electronic interaction data. The AI system uses the touchpoint contributions to identify those touchpoints 212 that contribute the most to the conversion event 234, and optimizes content information for those touchpoints 212. For example, the brand search 232 has a touchpoint contribution of 50% which is the highest amount of touchpoint contribution among the touchpoints 212 for the decision path P 210. Therefore, the AI system optimizes content information associated with the brand search 232, allocates more technical resources for server devices associated with the brand search 232, increases bandwidth for communications and infrastructure equipment associated with the brand search 232, and so forth. These actions collectively increase the effectiveness of the brand search 232, thereby leading to a reduced number of touchpoints 212 needed for future decision path P 210

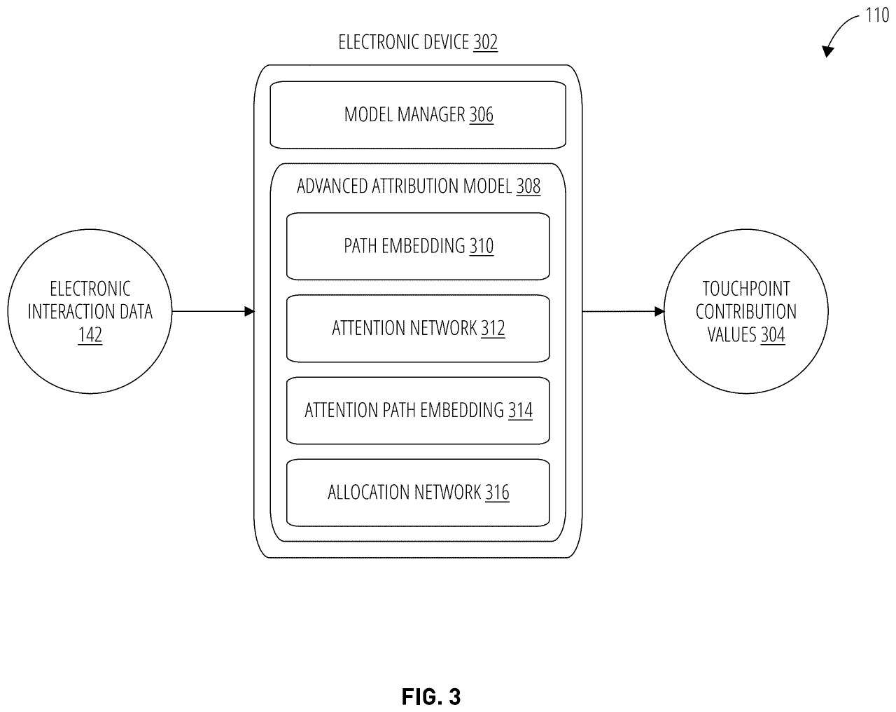

FIG. 3 illustrates an example architecture or framework for an AI system 110. As depicted in FIG. 3, the AI system 110 comprises an electronic device 302 to perform training operations and/or inferencing operations for the AI system 110.

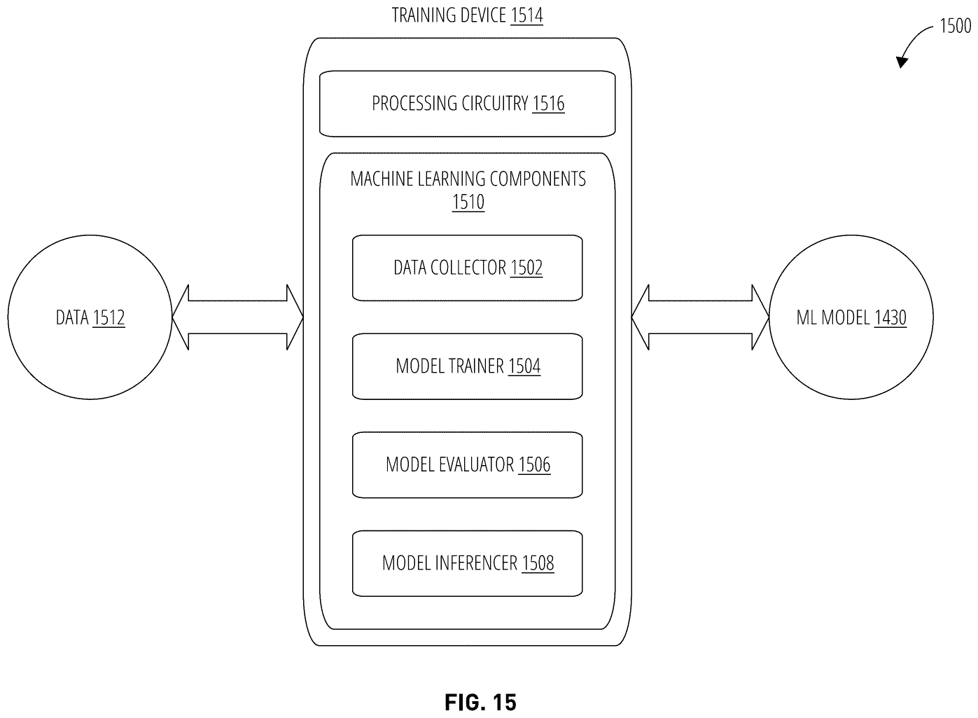

The electronic device 302 receives as input the electronic interaction data 142. When in a training mode, a model manager 306 performs training operations to train an advanced attribution model 308 using the electronic interaction data 142. When in an inferencing mode, the model manager 306 performs inferencing operations that use the trained advanced attribution model 308 to generate touchpoint contribution values 304 using the electronic interaction data 142. Training operations for the advanced attribution model 308 are described in more detail with reference to FIG. 15.

With respect to inferencing operations, the electronic device 302 comprises hardware, software, and/or firmware to execute instructions for the advanced attribution model 308 to cause the advanced attribution model 308 to generate a path embedding 310 representing a decision path 202 comprising a set of touchpoints 212 to obtain a defined outcome, such as conversion event 234. Each touchpoint 212 comprises an electronic interaction between electronic devices, such as client system 122 and the server system 128 and/or the connections networking system 102. The advanced attribution model 308 generates an attention path embedding 314 based on the path embedding using an attention network 312. In one embodiment, for example, the attention path embedding 314 comprises a set of aggregated attention weights for the set of touchpoints 212 in the decision path 202.

In various embodiments, the aggregated attention weights represent multiple sets of attention weights from one or more attention heads that are mathematically aggregated using any suitable function. Non-limiting examples of aggregation functions include a simple average, a weighted average, a minimum (min) maximum (max) pooling, and other aggregation functions. Embodiments are not limited in this context.

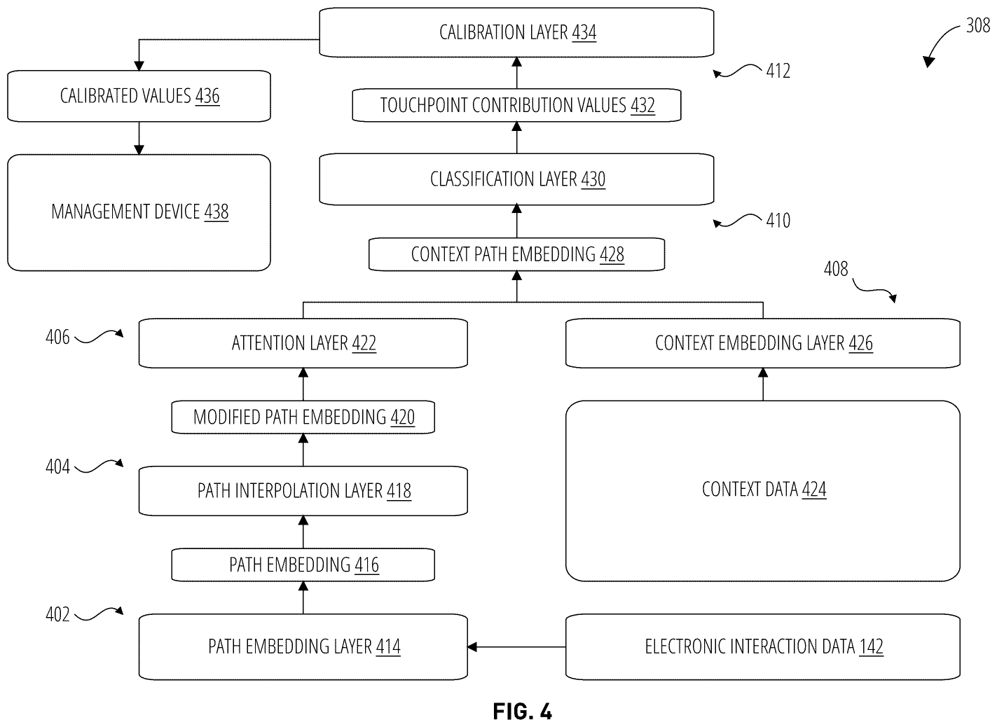

The advanced attribution model 308 generates a set of touchpoint contribution values 304 corresponding to the set of touchpoints 212 based on the attention path embedding 314 using an allocation network 316. A touchpoint contribution value from the set of touchpoint contribution values 304 represents a level of contribution made by a touchpoint 212 from the set of touchpoints 212 to obtain the defined outcome, such as conversion event 234. The model manager 306 then passes the touchpoint contribution values 304 to a management system for use in various downstream tasks, such as providing a recommendation for the connections networking system 102 based on the touchpoint contribution values 304. Inferencing operations for the advanced attribution model 308 are described in more detail with reference to FIG. 4.

FIG. 4 illustrates a more detailed example architecture or framework for an advanced attribution model 308 of an AI system 110. The advanced attribution model 308 comprises different layers implementing different sets of operations for one or more ML models 138 supporting the advanced attribution model 308.

As depicted in FIG. 4, the AI system 110 comprises a path embedding layer 414 to implement a generative model 402, a path interpolation layer 418 to implement a path interpolation model 404, and an attention layer 422 to implement an attention model 406 for the attention network 312. The AI system 110 also comprises a context embedding layer 426 to implement a generative model 408, a classification layer 430 to implement a classification model 410 for the allocation network 316, and a calibration layer 434 to implement a calibration model 412. Although the various layers are shown as combined into a single ML model, it may be appreciated that the layers may be separated as multiple ML models, based on factors such as speed, size, training data, or processing requirements for a given implementation. Embodiments are not limited in this context.

The AI system 110 comprises a path embedding layer 414 to implement operations for a generative model 402. In one embodiment, for example, the generative model 402 is implemented as an LLM, such as a transformer model like a Generative Pre-Trained Transformer (GPT) model or a bi-directional encoder representations from transformers (BERT) model, using a transformer architecture specifically fined-tuned for generating human-like conversational responses. The LLM utilizes deep learning techniques to understand and generate natural language text. The path embedding layer 414 receives as input the electronic interaction data 142, analyzes the electronic interaction data 142 for patterns representative of a decision path 202, and generates a path embedding 416 for the decision path 202. The path embedding 416 is similar to the path embedding 310 described with reference to FIG. 3.

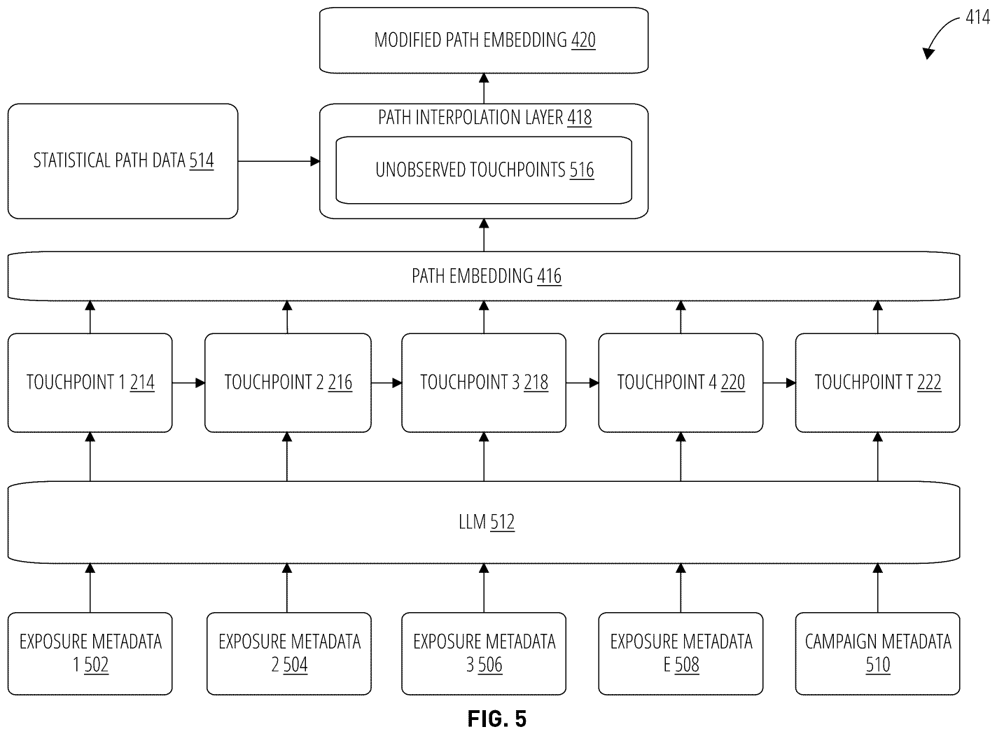

The path embedding layer 414, particularly in the context of neural networks, is a specialized layer that transforms high-dimensional inputs (like words, symbols, or categorical features) into a lower-dimensional, dense vector representation. The path embedding layer 414 attempts to capture the semantic relationships between the inputs in a way that positions similar inputs closer together in the embedding space. This layer is used in natural language processing (NLP) applications to convert text data into vectors, since models cannot work directly with raw text. It enables the model to understand the input features better by learning an embedding for each input token (e.g., word or character) during the training process. The path embedding layer 414 helps the advanced attribution model 308 achieve better performance on tasks like text classification, sentiment analysis, and language translation by providing a more expressive and compact representation of the input data. The path embedding layer 414 is described in more detail with reference to FIG. 5.

The AI system 110 comprises a path interpolation layer 418 to implement operations for a path interpolation model 404. The path interpolation layer 418 receives as input the path embedding 416, analyzes the path embedding 416 for patterns representative of missing touchpoints 212, and generates a modified path embedding 420 with interpolated or imputed touchpoints 212 to augment the decision path 202. The path interpolation layer 418 compensates for missing data in the decision path 202. It specifically addresses the issue of missing or incomplete data within electronic interaction data 142. This layer is designed to estimate and fill in missing values based on the available electronic interaction data 142, allowing the model to utilize a full dataset without discarding records that have incomplete information. Interpolation can be achieved through various techniques, such as linear interpolation, where missing values are filled based on linear relationships among data points, or more complex methods like polynomial interpolation or spline interpolation, which can capture non-linear relationships. In the context of deep learning, the path interpolation layer 418 might involve more sophisticated mechanisms, such as utilizing the patterns learned by the model to predict the missing values accurately. A goal of path interpolation layer 418 is to enhance data quality and completeness, thereby improving the model's performance by leveraging more informative and comprehensive inputs during training and inference. This layer plays a role in ensuring that the predictions made by the advanced attribution model 308 are reliable and based on a more complete understanding of the underlying data patterns.

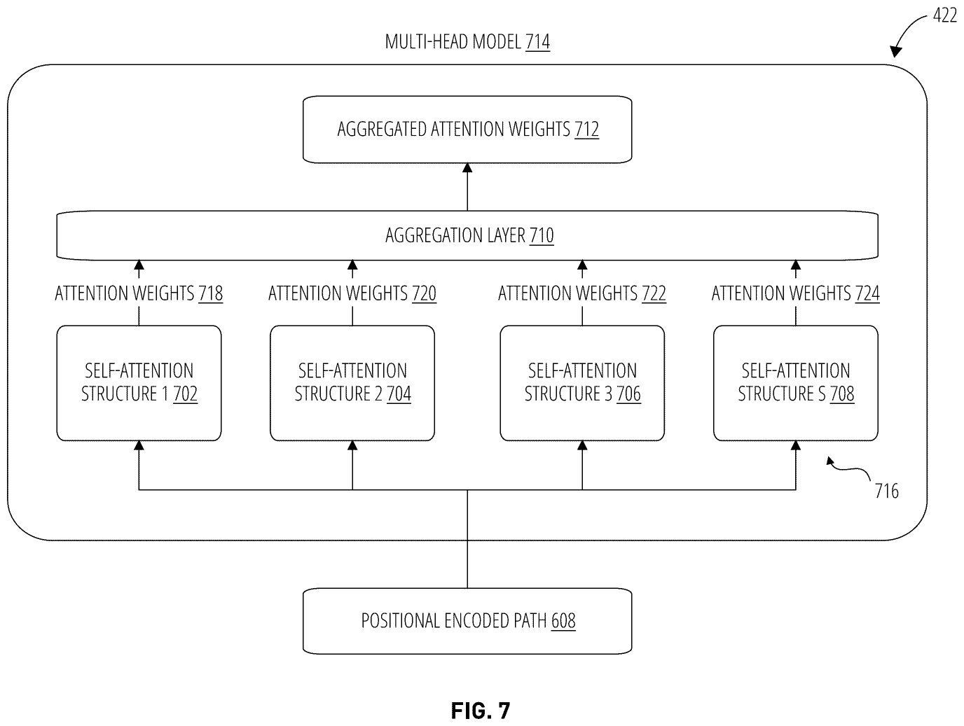

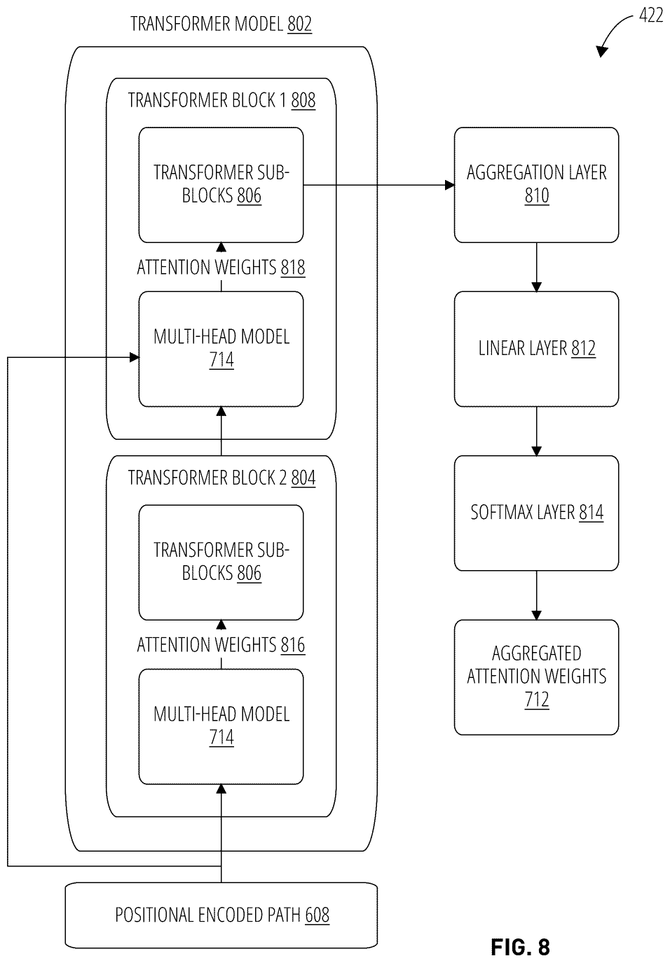

The AI system 110 comprises an attention layer 422 to implement operations for an attention model 406. In one embodiment, for example, the attention model 406 is implemented as a transformer model using a multi-head attention technique, such as a GPT or BERT. The attention layer 422 receives as input the modified path embedding 420, analyzes the modified path embedding 420, and generates a set of attention weights for the modified path embedding 420 to form a final path embedding for the decision path 202. A transformer, such as a GPT or BERT, is a core component designed to weigh the importance of different input parts differently when processing data. The attention mechanism allows the model to focus on specific parts of the input data that are more relevant to the task at hand, improving the ability of the model to understand context and relationships in the data. In the context of transformers and models like ChatGPT, the attention layer 422 specifically employs a mechanism known as self-attention or intra-attention. This mechanism enables each output element to be computed as a weighted sum of a function of all input elements, where the weights are determined based on the relevance of each input element to the output. The self-attention mechanism in attention layer 422 operates by creating three vectors for each input token: a query vector, a key vector, and a value vector, all derived from the input embedding through learned transformations. The relevance, as denoted by attention scores, between each pair of tokens is computed by taking the dot product of their query and key vectors, followed by a scaling factor and a SoftMax operation to obtain the weights. These weights are then used to aggregate the value vectors, resulting in an output that reflects both the content of each token and the contextual relationships between tokens. This capacity to dynamically weight the input elements enables transformers to handle sequences of data in a flexible and powerful manner, making them highly effective for a wide range of tasks in natural language processing, including language modeling, text generation, translation, and more. The attention layer 422 is described in more detail with reference to FIG. 7 and FIG. 8.

The AI system 110 also comprises a context embedding layer 426 to implement operations for a generative model 408. In one embodiment, for example, the generative model 408 is a LLM such as a GPT or BERT similar to the generative model 402. However, in some examples, the generative model 408 is trained on a private dataset, such as the connections data 116 and entity data 118 from the connections networking system 102. The context embedding layer 426 receives as input connections data 116 from the connections networking system 102. The connections data 116 comprises different types of data, such as entity data 118 and member data for users, members, customers, subscribers, or other individuals. The context embedding layer 426 analyzes the connections data 116 and it generates one or more contextual embeddings.

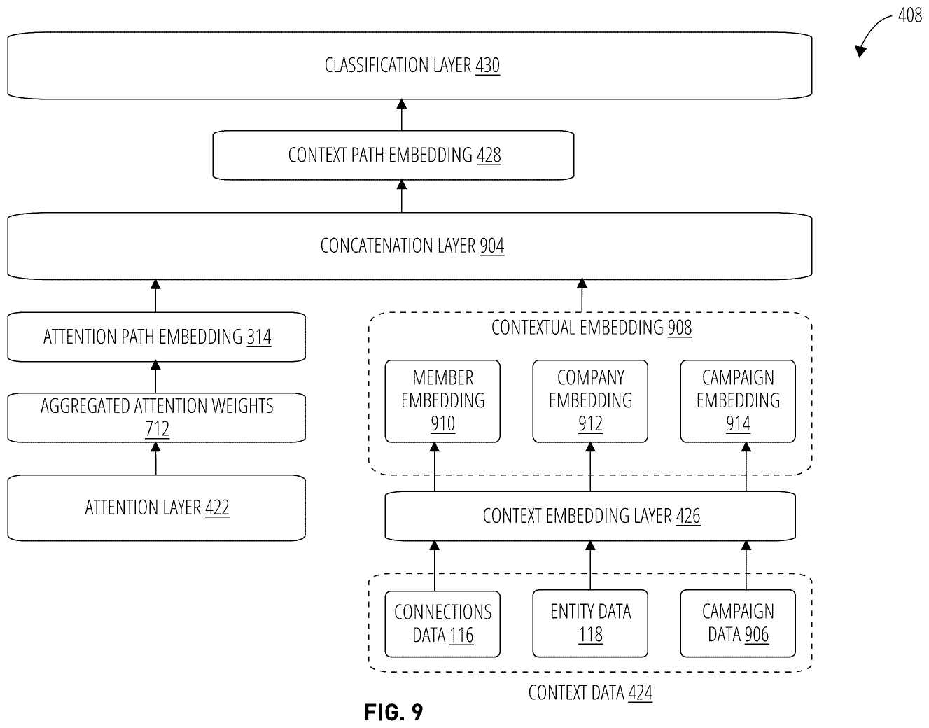

A concatenation layer (shown in FIG. 9) of the AI system 110 combines the outputs of the attention layer 422 and the context embedding layer 426 into a context path embedding 428. The concatenation layer is described in more detail with reference to FIG. 9.

The AI system 110 further comprises a classification layer 430 to implement operations for a classification model 410. The classification layer 430 receives as input the context path embedding 428, analyzes the context path embedding 428, and generates a set of touchpoint contribution values 432 for the touchpoints 212 in the decision path 202. The classification model 410 is an algorithm that is trained to categorize data into specific labels or classes based on its features. The process involves learning from a training dataset, where each instance is associated with a label, and the model adjusts its parameters to be able to predict the correct class for unseen instances. Classifiers can be used for a range of tasks, including spam detection, image recognition, sentiment analysis, and more. There are various types of classifiers, each with its strengths and suitable applications. Non-limiting examples of classifiers include: (1) decision trees which are models that use a tree-like graph of decisions and their possible consequences to make predictions; (2) support vector machines (SVM) that find the hyperplane that best separates different classes in the feature space; (3) a naive Bayes classifier that is a probabilistic classifier based on applying Bayes theorem with strong (naive) independence assumptions between the features; (4) logistic regression classifier which uses logistic regression for binary classification to estimate probabilities that a given instance belongs to a particular class; (5) neural network classifier that is a complex model that can learn nonlinear relationships between features and classes, especially useful for large datasets with complex patterns; (6) random forest classifier that is an ensemble method that uses multiple decision trees to improve classification accuracy and control over-fitting. The choice of a given classifier depends on the specific requirements of the task, including the nature of the input data, the complexity of the decision boundary, the need for interpretability, and computational efficiency considerations.

In one embodiment, for example, the classification model 410 is a binary classifier, such as a logistic regression (LR) classifier. Logistic regression is a statistical model used for binary classification tasks, where the goal is to predict the probability of an outcome belonging to one of two classes. Unlike linear regression, which predicts a continuous value, logistic regression predicts a probability that maps to two discrete outcomes using the logistic (sigmoid) function. The logistic function ensures that the output of the regression equation, which can be any real number, is transformed into a value between 0 and 1, representing the probability of the target class. The model is trained by finding the best-fitting parameters (coefficients) that maximize the likelihood of the observed data, often using techniques like maximum likelihood estimation. Logistic regression is particularly valued for its simplicity and interpretability. The model produces coefficients for each feature, which can be used to understand the impact of each predictor on the likelihood of the target event. This makes it a popular choice for applications where understanding the relationship between predictors and the outcome is important, such as in medical diagnosis, marketing, and social sciences. Despite its simplicity, logistic regression can be extended to handle multiclass classification problems (using techniques like one-vs-rest or multinomial logistic regression) and can be regularized (using L1 or L2 regularization) to prevent overfitting.

The AI system 110 also comprises a calibration layer 434 to implement operations for a calibration model 412. The calibration layer 434 receives as input the touchpoint contribution values 432, analyzes the touchpoint contribution values 432, and generates a set of calibrated values 436 for the touchpoint contribution values 432. The calibration layer 434 is a post-processing operation designed to adjust the output probabilities of an attention model 406 so that they better represent true probabilities of the predicted outcomes. Many models, especially complex ones like deep neural networks, may make accurate predictions in terms of the class labels but could output probability scores that are not well-calibrated. For instance, a model might predict a certain class with high confidence (e.g., 90% probability) when, in reality, when making that prediction, it is correct only 70% of the time. The calibration layer 434 aims to correct this discrepancy. The calibration layer 434 essentially refines the touchpoint contribution values 432 to ensure that the predicted probabilities accurately reflect the likelihood of an event or class membership. This layer is for applications where decision-making relies not just on the predicted class but also on the uncertainty of that prediction. Two approaches for implementing a calibration layer 434 are: (1) Platt scaling or logistic calibration; and (2) isotonic regression. Platt scaling fits a logistic regression model to the uncalibrated probabilities. It is particularly well-suited for binary classification problems. Isotonic regression is a non-parametric approach that fits a piecewise non-decreasing function to the uncalibrated probabilities. It can be more flexible than plat scaling and is useful for both binary and multi-class problems. After applying such a calibration layer 434, the touchpoint contribution values 432 are expected to be more interpretable and meaningful, which is particularly important for risk assessment, uncertainty estimation, and any context where trustworthiness of model predictions is critical.

The AI system 110, or the connections networking system 102, may implement a management device 438. The management device 438 may receive as input the calibrated values 436, and perform downstream tasks using the calibrated values 436. The calibrated values 436 are suitable for use by any number of downstream applications, such as reporting for internal business units, external facing business partners, vendors, and third-party entities. This approach enables better budget allocation, improved customer engagement, and enhanced overall marketing performance, leading to more informed decision-making and increased return on investment (ROI).

FIG. 5 illustrates an example architecture or framework for a path embedding layer 414 of the advanced attribution model 308. As depicted in FIG. 5, the path embedding layer 414 receives as input electronic interaction data 142. In one embodiment, the electronic interaction data 142 comprises exposure metadata, such as exposure metadata 1 502, exposure metadata 2 504, exposure metadata 3 506, exposure metadata E 508, where E represents any positive integer. Generally, exposure metadata is an embedding for a type of touchpoint. In one embodiment, the electronic interaction data 142 comprises campaign metadata, such as campaign metadata 510. Generally, campaign metadata is an embedding that captures information about a campaign, such as a type of campaign (e.g., a marketing campaign, sales campaign, product campaign, brand campaign, etc.), how the campaign was set up, campaign content, and so forth.

Exposure metadata represents any data collected for a user or a client system 122 that interacts with the connections networking system 102, the server system 128, and/or the security system 134. Exposure metadata describing an electronic interaction between a client system and a server system includes various types of information that detail the characteristics, processing, and management of the data exchanged during the interaction. Examples of exposure metadata are IP addresses, which identify the devices participating in the interaction; timestamps, marking the occurrence of specific actions; HTTP headers, providing information about the browser used, requested resources, and server responses; and session identifiers (IDs), which track the user's session for maintaining state and preferences across multiple requests. Other examples include user agent strings, detailing the client's operating system and browser version; referrer URLs, indicating the webpage that led the client to the current resource; the request method used (e.g., GET, POST) which specifies the action to be performed on the server; and metadata data related to content information 132, indicating a type of content objects accessed, a duration of access, a number of times accessed, and so forth.

An LLM 512 receives as input the electronic interaction data 142, analyzes the electronic interaction data 142, and generates touchpoints 212 for a decision path 202. The LLM 512 is trained to generate the touchpoints 212 based on a number of hyperparameters that define various path constraints for path creation, such as user-level, account-level, path length (e.g., a number of touchpoints 212), duration, a lookback window (e.g., a maximum number of days included in a decision path 202), and other types of path constraints. In one embodiment, for example, the hyperparameters define a decision path 202 using a last 50 attribution-eligible touchpoints that are either: (1) for converting paths: within a 60-day lookback window from the conversion date; or (2) for non-converting paths: within 60 days from the run date of when the training data is created. The hyperparameter of 50 touchpoints is based on a balance between day coverage (e.g., 41 days) and higher representation of paid media touchpoints (e.g., 2.75%). The hyperparameters are not limited to this example.

The LLM 512 receives the electronic interaction data 142, and it sequences them chronologically. Some of the electronic interaction data 142 arrive in mixed time granularities in which case deterministic rules are used to break any ties. The LLM 512 sequences all touchpoints 212 and conversion events 234 chronologically and slices the electronic interaction data 142 into decision paths 202 each time a conversion event 234 occurs. The LLM 512 uses event timestamps for sequencing when they are available. If a tie occurs, then a heuristic is used which orders events as Impressions>Clicks>Conversions. When a conversion event 234 does not occur, the decision path 202 remains open and is by definition the most recent activity. The LLM 512 may apply other business rules as needed such as limiting the number of days, the count of touches, or any specific inclusion/exclusion criteria when building the paths.

The LLM 512 then generates a touchpoint 1 214, a touchpoint 2 216, a touchpoint 3 218, a touchpoint 4 220, and a touchpoint T 222 based on an analysis of the chronologically sequenced exposure metadata 1 502, exposure metadata 2 504, exposure metadata 3 506, and exposure metadata E 508, respectively, to form a decision path 202. Each touchpoint 212 in the sequence is uniquely identified in the source system and enables the LLM 512 to utilize additional campaign metadata and time information. In one embodiment, the LLM 512 classifies each touchpoint 212 as a triple of (Campaign Group, Campaign Family, Action) with an example such as (Campaign Group 1, Campaign Family 1, Impression 1). The LLM 512 converts the triples to an integer ID for modeling. For example, the LLM 512 concatenates the triple to a string and that string is converted into an integer ID for modeling. The LLM 512 outputs a path embedding 416 representing the touchpoints 212 for the decision path 202.

The path interpolation layer 418 receives as input the path embedding 416, analyzes the path embedding 416 for unobserved touchpoints 516 missing from the touchpoints 212, and generates a modified path embedding 420 for the decision path 202 that includes the unobserved touchpoints 516. The path interpolation layer 418 implements a path interpolation model 404 trained to impute or interpolate unobserved touchpoints 516 between observed touchpoints 212 for the decision path 202. Due to privacy restrictions (e.g., GDPR, CCPA), the AI system 110 does not always have access to data for certain user-level touchpoints or conversions, particularly from third-party systems. The AI system 110 utilizes a path interpolation model 404 to perform a touchpoint imputation where a decision path 202 is missing unobserved actions (e.g., impressions) that may or may not lead to an observable action (e.g., a click). Using statistical path data 514 comprising statistics from internal and external aggregate level reporting, the path interpolation model 404 performs probabilistic injection of imputed user events to fill the gaps in the data.

In one embodiment, for example, the path interpolation layer 418 uses the statistical path data 514 to incorporate one or more unobserved touchpoints 516 representing missing impressions from paid media, such as probabilistic inclusion of aggregate paid channel data (impressions) to member-level paths, sessionization of touchpoints in member-level paths, and scaling output to reconcile attribution results at a channel-group level. The path interpolation layer 418 is trained to incorporate aggregate paid media impressions into decision paths 202 to correctly measure the effect of paid media at a campaign level. In some cases, training data for the path interpolation model 404 does not include impressions for paid media due to privacy constraints or inability to access third-party systems. This creates a bias in the representation of these types of third-party marketing channels, such as implemented by the server system 128, in comparison to marketing channels for the connections networking system 102 hosting the AI system 110. Additionally, if only clicks are accounted for in the path interpolation model 404 there can be bias between paid media channels and/or platforms as some platforms are more “click-friendly” than others. On the other hand, incorrect modeling assumptions can lead to incorrect attribution results for a campaign by over-estimating or under-estimating a true number of interactions from that campaign.

To compensate for missing touchpoints 212 from paid media channels of third-party systems, and corresponding bias in touchpoint contributions relative to non-paid media channels of systems hosting the AI system 110, the path interpolation layer 418 uses the statistical path data 514 to generate one or more unobserved touchpoints 516 from the observed touchpoints 212 in the decision path 202. For example, the path interpolation layer 418 adds probabilistic paid channel impressions in path data utilizing daily aggregate impression data and clicks to probabilistically add paid media impressions into decision paths 202. The statistical path data 514 for daily aggregate impressions and clicks for external (paid) marketing channels are sourced from a third-party aggregating service. In some cases, this data is aggregated and does not contain member identifiers, and therefore it is difficult to determine how many people these impressions and clicks are served to or how they are distributed across paths. To incorporate this data into the path interpolation layer 418, the path interpolation model 404 makes a connection between a daily sum of impressions and clicks to path-level impression-to-click ratio for each channel. Historical data shows a mean number of impressions-per-click per path is approximately 1% of the daily impression to click ratio. The distribution of the number of impressions follows a log-normal distribution. Therefore, the path interpolation model 404 is trained to probabilistically add paid media impressions to members and/or decision paths 202. For a given path and a paid media channel, for example, the path interpolation model 404 samples from a log-normal distribution with a mean of 1% of the daily impression-to-click ratio of that channel on that day, and a fixed variance. The path interpolation model 404 adds that many impressions to each click event. Next, the path interpolation model 404 calculates a number of expected impressions left for that paid media channel on each day using the estimated member to non-member ratio. The path interpolation model 404 includes impressions into each decision path 202 while limiting the total number of impressions added across all decision paths 202. The path interpolation model 404 samples from a log-normal distribution based on the historical analysis. Event dates are added using an exponentially decaying function start from the end date of each path.

In another example, the path interpolation layer 418 implements a secondary model at a DMA/zip code level to calibrate model output utilizing aggregate data at the DMA/zip code level to infer a relationship between clicks and impressions and re-calibrates output using this model. Additional dimensions like time or region can be used for more accurate modeling.

In yet another example, the path interpolation layer 418 models on clicks and then adds a scaling factor to adjust for click rate differences between media channels. In this case, paid media clicks are available at member level with high coverage rate. Clicks can be used in the model but a mechanism outside of the model is leveraged to estimate adjustment factors.

The path interpolation model 404 then outputs a modified path embedding 420 that provides a more comprehensive view for a customer journey characterized by the path embedding 416. As described with reference to FIG. 4, the path interpolation model 404 injects the imputed missing events and assumed embeddings for the individual touchpoints. The path interpolation layer 418 outputs the modified path embedding 420 to the attention layer 422 implementing the advanced attribution model 400. The attention layer 422 outputs an attention path embedding 314 using a set of aggregated attention weights 712.

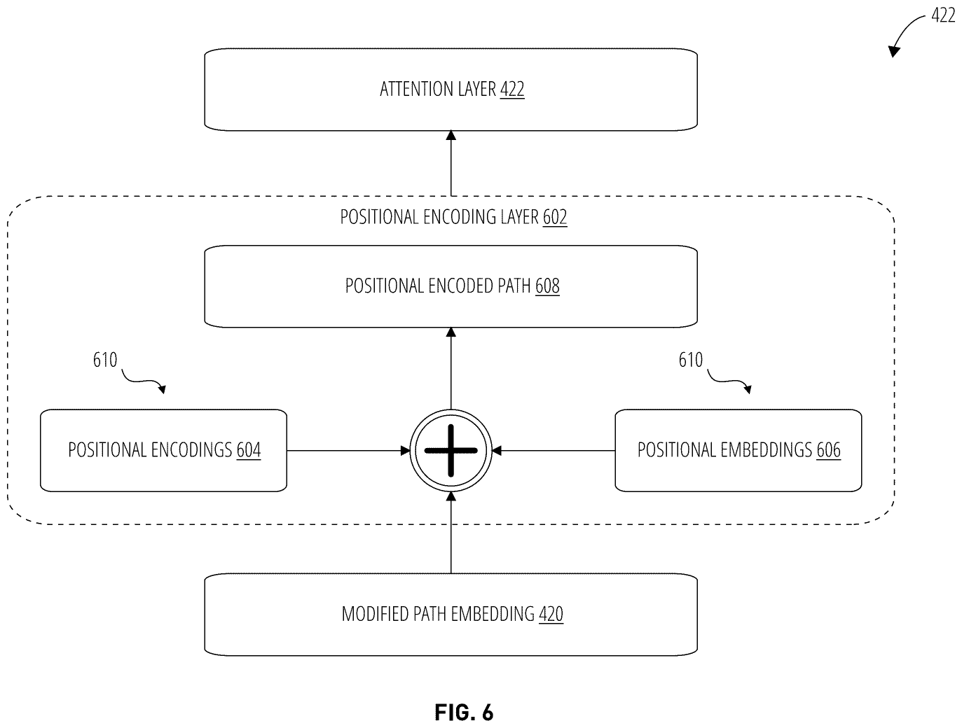

FIG. 6 illustrates an example of an architecture or framework for an attention layer 422 of the advanced attribution model 308. Specifically, FIG. 6 illustrates a positional encoding layer 602 for the attention layer 422.

The attention layer 422 implements an advanced attribution model 400 that receives as input the modified path embedding 420 representing a decision path 202 that includes observed touchpoints 212 generated from the electronic interaction data 142 and unobserved touchpoints 516 generated from the statistical path data 514. The advanced attribution model 400 is trained to generate a probability of a positive conversion event 234 as a binary classification task based on the modified path embedding 420 and other dimensional features. Each sequence contains up to N touches (e.g., N=50) where each touch can be one of T types (e.g., email send, impression, click, etc.). Each type is encoded into a D dimensional embedding such as a tensor of dimension (N, D) representing the decision path 202. A multi-head self-attention layer encodes the modified path embedding 420 and then combines it with other member features for a final prediction. The attention weights are used to allocate credit to the N-th touchpoint.

In order to improve efficiency and effectiveness of the attention layer 422, a positional encoding layer 602 receives as input the modified path embedding 420, and it generates positional information for the modified path embedding 420. Conventional attention-based layers typically do not have an ordering of inputs. Further, there is no guarantee that a model needs to weigh the sequence heavily, if at all, for its final prediction. In an extreme example, it could be possible to learn a high accuracy P(Conversion) strictly from dimensional features. To compensate for these two deficiencies, the AI system 110 adds positional information to allow the advanced attribution model 308 to correctly utilize positions when generating attention scores.

To allow for the ordering of a sequence in an attention/transformer model, the AI system 110 adds some additional encoding or embedding to the sequence input which allows the advanced attribution model 308 to differentiate between time steps. When this position information is static, they are referred to as positional encodings 604 and are typically derived from a sinusoidal function. These positions can also be learned, in which case they are referred to as positional path embeddings 416. This is the approach used by BERT and other models. One challenge is that as the dimensionality of the inputs decreases, the positional encodings lose their monotonicity. This causes conventional models to have a degraded ability to differentiate across time steps. Lower dimensions are common in time-series data and this is also true for electronic interaction data 142 where there is normally only 16 distinct touch types, excluding campaign-level features, for example. Therefore, the advanced attribution model 308 is trained to reduce or eliminate this problem. Further, the advanced attribution model 308 may use variable encoding formulas that account for sequence length to create a smoother monotonic function.

The electronic interaction data 142 contains a feature which indicates a number of days an interaction occurred prior to a conversion event 234, or a current date if not converting, for up to 60 days, for example. Instead of using this feature as a numeric input, the advanced attribution model 308 treats each day as a discrete value and passes it through an embedding lookup layer. There are two reasons for this design decision. First is that each time step in the decision path 202 is not uniform. The time difference between any two time steps can range from [0, 60]. Further, these events are not monotonic since multiple interactions can occur on the same day. This differs from other time series or NLP tasks where each time step often has some uniform progression. Second, the advanced attribution model 308 is forced to use date information. After converting the days to an embedding, date information is added so that the advanced attribution model 308 can also differentiate between an absolute position of touchpoints 212, even if occurring on the same day.

The positional encoding layer 602 receives the modified path embedding 420, and encodes position information for the modified path embedding 420 using the positional encodings 604 and/or positional embeddings 606. The positional encoding layer 602 outputs a positional encoded path 608 for processing by the attention layer 422.

FIG. 7 illustrates an example of an architecture or framework for an attention layer 422 of the advanced attribution model 308. Specifically, FIG. 7 illustrates a multi-head model 714 for the attention layer 422.

The advanced attribution model 308 uses a deep neural network with classification layer 430 to measure the partial contributions of each touchpoint 212 in a decision path 202. Example inputs to the advanced attribution model 308 include the decision path 202 as represented by the positional encoded path 608, member embeddings, company embeddings, and campaign embeddings.

In one embodiment, for example, the advanced attribution model 308 is trained to predict P(C|E_{M,} E_{c,} S) where S is a sequence of marketing interactions of length T containing p touchpoints for each timestep t, where pₜ∈{p₀, . . . , p_{K+1}}, where K is the distinct number of possible touches/channels. The sequence S is limited to N touches such paths with count of T>N are truncated and T<N are padded with 0. The conversion event 234 is not included in the decision path 202. Each touchpoint is converted to an embedding E_{T}. The E_{M} is a member embedding vector of length D_{M} sourced from an external model. The E_{C} is a company embedding vector of length D_{C} sourced from an external model for the primary company associated with that member. A binary outcome label y indicates the conversion event 234 of the decision path 202.

For each sequence S, the advanced attribution model 400 obtains a feature vector capturing unique information about the touchpoint pₜ. Each touchpoint 212 represents a marketing interaction as a triple as previously described. This integer encoding is used to train a D_{E} embedding lookup layer representing each of the touch types. After encoding there is a sequence representation of shape (T, D_{E}).

To enhance decision path modeling, the positional encoding layer 602 adds positional information to the modified path embedding 420 to form the positional encoded path 608 as described with reference to FIG. 6. Attention models do not normally have a concept of position so additional encodings are needed to capture relative positions. For certain attention models, such as the BERT model, sinusoidal positional encodings 604 allow for order differentiation. However, positional encodings 604 are non-trainable and therefore modern BERT models use learnable positional embeddings 606. The advanced attribution model 308 uses a combination of both positional encodings 604 and positional embeddings 606. The positional encoding layer 602 treats the integer days before conversion as discrete values and performs an embedding lookup to obtain a learnable value E_{D} for each day. One benefit is that this accommodates irregular sequence data. Unlike NLP models or true time-series forecasting, members do not have a continuous stream of events. By transforming the days to a positional path embedding 416 the advanced attribution model 308 is able to leverage this temporal irregularity.

Multiple activities can still occur on the same day. So to preserve intra-day ordering, the positional encoding layer 602 also adds the positional encodings 604. The combination of these embeddings allow for both relative and absolute differentiation. In one embodiment, the original positional embeddings 606 are modified using a Time Absolute Position Encodings (tAPE) technique, which scales the encodings to improve performance in lower dimensional representations. Testing these modifications yielded significant performance increases in the advanced attribution model 308.

These concepts are combined together as concat(tAPE(E_{T}+E_{D}), E_{MCID}), where E_{MCID} is a marketing campaign vector obtained from an encoding of the campaign metadata, such as a BERT encoding, for example.

To assist in classification operations for the classification layer 430, the advanced attribution model 308 utilizes an attention layer 422 implementing an attention model 406. In one embodiment, for example, the attention model 406 is a self-attention model. The sequences from the decision path 202 are passed through a multi-head attention layer 422 with masking for padded time steps in the decision path 202.

As depicted in FIG. 7, the multi-head model 714 of the attention layer 422 receives the positional encoded path 608. The multi-head model 714 passes the positional encoded path 608 through one or more self-attention structures, such as self-attention structure 1 702, self-attention structure 2 704, self-attention structure 3 706, and self-attention structure S 708, where S represents any positive integer. Each of the self-attention structures are configured to output a set of attention weights. However, attention weights from a single head may be sensitive to noise or outliers. To address this, the multi-head model 714 implements multiple self-attention structures that each output a set of attention weights to an aggregation layer 710.

The aggregation layer 710 aggregates information from the diverse attention heads. In an attention network with multiple attention heads, each head independently computes attention scores and produces a set of output values. These outputs are then aggregated to form a single combined representation. For example, the outputs of all the attention heads are concatenated. The concatenated output is linearly transformed to a desired output dimension. This process allows the multi-head model 714 to capture information from different representation subspaces at different positions, enhancing the ability of the model to focus on various aspects of the input sequence simultaneously.

In one embodiment, for example, the aggregation layer 710 receives attention weights from each of the self-attention structures and calculates an average of the multiple single-head attention weights to increase stability of touchpoint contributions to the touchpoints 212 of the decision path 202. In this manner, the advanced attribution model 308 uses the multi-head model 714 to provide more robust and reliable attribution results.

FIG. 8 illustrates an example architecture or framework for an attention layer 422 for the advanced attribution model 308. Alternatively, or in addition to, the multi-head model 714, the attention layer 422 uses a transformer model 802. In one embodiment, for example, the advanced attribution model 308 uses a full transformer block with the multi-head model 714 and performs aggregation on outputs of the transformer blocks.

As depicted in FIG. 8, the advanced attribution model 308 implements a transformer model 802 that comprises multiple transformer blocks, such as transformer block 2 804 and transformer block 1 808. The transformer block 2 804 comprises a multi-head model 714 and transformer sub-blocks 806. The transformer block 1 808 also comprises a multi-head model 714 and transformer sub-blocks 806. Although the transformer model 802 illustrates only two transformer blocks, it may be appreciated that the transformer model 802 may use more or less transformer blocks for a given implementation. Embodiments are not limited to this example.

In an attention network with multiple transformer blocks and multiple attention heads, the aggregation process occurs both within each block and across the blocks. Within a single transformer block, such as transformer block 2 804 or the transformer block 1 808, each attention head of the multi-head model 714 independently computes attention scores using its own set of parameters, producing separate outputs. These outputs are then concatenated and linearly transformed to integrate information from all heads. This multi-head attention mechanism allows the model to focus on different parts of the input sequence simultaneously. Following the multi-head attention, the transformer sub-blocks 806 implement a feed-forward neural network to further process the combined output, with residual connections and layer normalization applied to ensure stable training and better gradient flow.

Across multiple transformer blocks, such as transformer block 2 804 and transformer block 1 808, the output from each block is passed as input to the subsequent block. Each transformer block contains its own multi-head attention and feed-forward layers, enabling the network to refine the representation of the input data progressively. This sequential processing allows the model to capture increasingly complex patterns and dependencies in the data. By stacking multiple transformer blocks, the network aggregates and integrates information at various levels, ultimately producing a refined output suitable for tasks like classification, translation, or other natural language processing applications.

Specifically, the transformer block 2 804 receives as input the positional encoded path 608. The multi-head model 714 analyzes the positional encoded path 608 and outputs a first set of aggregated attention weights 712 to the transformer sub-blocks 806. The transformer sub-blocks 806 perform normal transformer operations, such as layer normalization, residual connections, and feed forward operations. The transformer sub-blocks 806 of the transformer block 2 804 outputs the aggregated attention weights 712 to the transformer block 1 808. The multi-head model 714 of the transformer block 1 808 analyzes the positional encoded path 608 and outputs a second set of aggregated attention weights 712 to the transformer sub-blocks 806 of the transformer block 1 808. The transformer block 1 808 aggregates the first set of aggregated attention weights 712 and the second set of aggregated attention weights 712 using an aggregation layer 810. The aggregated attention weights are passed through a linear layer 812 and SoftMax layer 814 to output a final set of aggregated attention weights 712.

FIG. 9 illustrates an example of an architecture and framework for a context embedding layer 426 implementing a generative model 408 of the advanced attribution model 308.

As previously described, the output of the attention layer 422 is a set of aggregated attention weights 712 that are added to the modified path embedding 420 to form a final path embedding, such as the attention path embedding 314. The attention path embedding 314 is passed to a concatenation layer 904.

In parallel, or in sequence, to generating the attention path embedding 314, the context embedding layer 426 receives a set of context data 424, and it generates a contextual embedding 908. The contextual embedding 908 comprises features representative of various entities associated with the decision path 202. The aggregated attention weights 712 for the decision path 202 are influenced by interactions between various entities, such as marketing campaigns, members, advertisers, and companies. These entities have complex features which are difficult to model independently.

In one embodiment, for example, the context embedding layer 426 implements the generative model 408, such as a LLM like GPT or BERT, that is trained using context data 424 for the decision path 202 to produce common embedding representations. This is achieved by constructing natural language descriptions of each entity and using the LLM to generate the transformed embedding used for attribution modeling. In one embodiment, for example, the generative model 408 is trained on domain specific training data. For instance, the generative model 408 may be implemented as an LLM such as BERT that has been pre-trained on a corpus of data from the connections networking system 102, such as connections data 116 and/or entity data 118. The BERT language model is trained on various types of connections data 116, such as member profiles, job postings, articles, search queries, and so forth. The domain specific model creates better representations and pick up on specialized words that generally trained versions of BERT would not capture as well.

In operation, the context embedding layer 426 retrieves one or more fields that describe an entity and it then transforms the one or more fields into a natural language sentence. For example, assume the context embedding layer 426 retrieves a set of fields (e.g., SPONSORED_UPDATE, LMS, US, CAMPAIGN MANAGER). The context embedding layer 426 transforms this set of fields into a natural language sentence, such as “A marketing campaign for LMS in the US region advertising Campaign Manager using the Sponsored Update format.” The natural language sentence is fed as input into a BERT model to generate a numerical embedding. The language model technique provides significant improvements relative to a conventional one-hot encoding of the different fields.

As depicted in FIG. 9, the context data 424 comprises connections data 116, entity data 118, and campaign data 906. The connections data 116 comprises data for one or users or members of the connections networking system 102 associated with the decision path 202. The entity data 118 comprises data for one or more entities (e.g., companies, businesses, organizations, etc.) of the connections networking system 102 associated with the decision path 202. The campaign data 906 comprises data for one or more campaigns associated with the decision path 202. Embodiments are not limited to these examples of context data 424.

The context embedding layer 426 receives as input the context data 424 associated with the decision path 202, and it generates a contextual embedding 908 for the decision path 202. For example, the context embedding layer 426 receives as input the connections data 116, entity data 118, and campaign data 906, and it generates a member embedding 910, company embedding 912, and campaign embedding 914, respectively. In one embodiment, for example, the context embedding layer 426 uses D_{C}=D_{M}=100 sized mean-pool embeddings to capture features about the member engaging in touchpoints 212 of the decision path 202 and the company to which the member belongs in the model. The member embedding 910 and company embedding 912 are passed through a bilinear layer and connected to a classification head of the classification layer 430. These features are used by the model to adjust the conversion probability as it is likely two members will not share the same baseline probability. These embeddings are based on basic member attributes such as industry, skills, and geography. Embodiments are not limited to using these types of embeddings in the model, and others are used as well. The contextual embedding 908 is passed to the concatenation layer 904.

The concatenation layer 904 receives the attention path embedding 314 and the contextual embedding 908, and it concatenates both embeddings into a context path embedding 428. The concatenation layer 904 passes the context path embedding 428 to the classification layer 430.

The classification layer 430 implements a classification model 410 to perform classification operations for the advanced attribution model 400. In one embodiment, for example, the classification model 410 is a binary classifier, such as a logistic regression (LR) classifier. The LR classifier is implemented in TensorFlow. Each sample in the model represents a decision path 202 comprising one or more touchpoints 212. Each touchpoint 212 represents an interaction taken by a user. For example an impression that was shown to a user or an advertisement 226 on which a user clicked. The classification model 410 is trained on converting (e.g., y=1) and non-converting (e.g., y=0) paths as a binary classifier. To be able to use embeddings and architectures like a recurrent neural network (RNN) or a long short-term memory (LSTM), the number of touchpoints 212 is limited to the last N interactions. Each decision path 202 contains a sequence of touchpoints 212, S={p₀, . . . , p_{K+1}} where K is the distinct number of previous interactions. If K<N in a decision path 202, the decision path 202 is padded with zeroes. Similarly if K>N, only the last N interactions are taken.

Features are derived from the touchpoints 212. The current features used in the model are comprised of four components: (1) a number of unique touchpoint types, e.g., Paid Search|Company|Click; (2) a member embedding vector E_{M} of length D_{M}; and (3) a company embedding vector E_{C} of length D_{C}. In one embodiment, for example, the classification model 410 uses D_{C}=D_{M}=100 sized mean-pool embeddings. For example, the classification model 410 uses N=30 to limit decision path 202 to the last 30 events.

The sequence S is transformed into, for example, the cumulative frequency of each touchpoint p at T_{N}. The aggregated touch counts are concatenated with member embedding 910 and company embedding 912 to produce an input vector of length sum(D_{M}, D_{C}, N). In some cases, for example, N can be more than the cumulative frequency. The concatenated vector is passed through a single fully connected layer with a single sigmoid output head. The binary cross entropy loss of the P(Conversion=1) is measured against y.

During inference, each sequence S is exploded into s instances such that each instance represents the composition of the path as of Tᵢ {p_{T0}, . . . , p_{Ti}} where i is from 1 through T. A decision path 202 comprising T=3 touches {p_{A}, p_{B}, p_{C}} would yield 3 observations such as {p_{A}}, {p_{A}, p_{B}}, {p_{A}, p_{B}, p_{C}}. For each iteration, the same process of aggregating counts by channel is performed. Each instance is passed through the trained model to obtain a P(Conversion|s). The relative change C in probability for each s of S is computed as C=max (sᵢ−sᵢ₋₁, 0). The relative values of C yield some change in probability of conversion which is interpreted as the magnitude of impact. The relative change C is constrained to be positive under the assumption that a marketing intervention does not produce a negative impact. Depending on the business rules for attribution, this negative constraint can be lifted. In the first time step, there is no model prediction to compute a relative change. A baseline is used where all touches are set to 0 and a P(Conversion) is computed using the member embedding 910 and the company embedding 912.

In one embodiment, for example, once all relative impacts have been calculated, they are normalized using Cₛ/ΣCₛᵢ such that they equal to 1. The normalized values of C can then be used to distribute credit across the touchpoints 212. These values are referred to as touchpoint contributions. The touchpoint contributions are additive across touchpoints 212 or across decision paths 202 for use in measuring attribution impact. A term touchpoint lift, which follows a similar methodology, is defined as a measure of how impactful touchpoints 212 are with respect to affecting the probability of successful outcome. The term touchpoint lift is expressed as a ratio of max(P(Conversion|sᵢ)/P(Conversion|sᵢ₋₁), 0).

The classification layer 430 receives as input the context path embedding 428, analyzes the context path embedding 428, and generates a set of touchpoint contribution values 432 for the touchpoints 212 of the decision path 202. In one embodiment, for example, the output of the multi-head attention layer is a T×T×H dimensional tensor where H is the number of heads in the attention layer. The attention layer 422 then takes a mean value across the H heads and obtains a T×T tensor that is then flattened into a single vector. This vector is concatenated by the concatenation layer 904 with the output of the bilinear layer of the context embedding layer 426 from the context data 424 inputs to form context path embedding 428. The shared representation passes through a single fully connected layer. The classification model 410 of the classification layer 430 takes a sigmoid output of the classification head and measures the binary cross entropy loss of the P(Conversion=1) against y. The classification layer 430 then outputs the touchpoint contribution values 432 to the calibration layer 434.

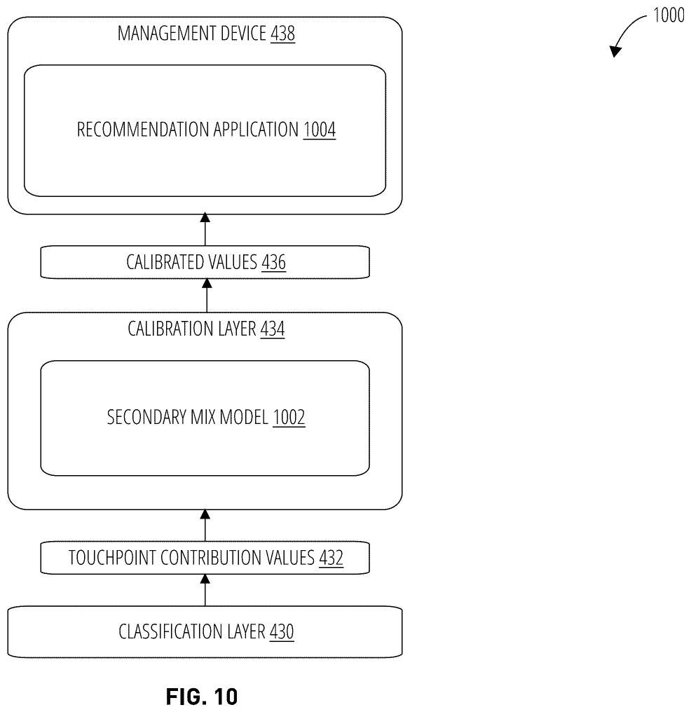

FIG. 10 illustrates an example architecture or framework for a calibration layer 434 that implements a calibration model 412 to perform calibration operations for the advanced attribution model 308.

The classification layer 430 takes as input the context path embedding 428 and it generates a set of touchpoint contribution values 432 for the set of touchpoints 212 of the decision path 202. The touchpoint contribution values 432 are output to a calibration layer 434 implementing a calibration model 412. In one embodiment, for example, the calibration layer 434 implements a calibration model 412 such as a secondary mix model 1002. The secondary mix model 1002 is a secondary model at a defined level to calibrate output from the classification layer 430. For example, the secondary mix model 1002 is a secondary model at a DMA or zip code level to calibrate output from the classification layer 430. Using aggregate data at the DMA/zip code level, the calibration layer 434 infers a relationship between clicks and impressions and re-calibrates the output using this model. Additional dimensions like time or region can be used for more accurate modeling. Embodiments are not limited to these examples.

The calibration layer 434 receives as input the set of touchpoint contribution values 432 and it outputs a set of calibrated values 436 for the set of touchpoint contribution values 432. The calibrated values 436 are output to a management device 438. The management device 438 executes a recommendation application 1004 that uses the calibrated values 436 for various downstream tasks, as previously described.

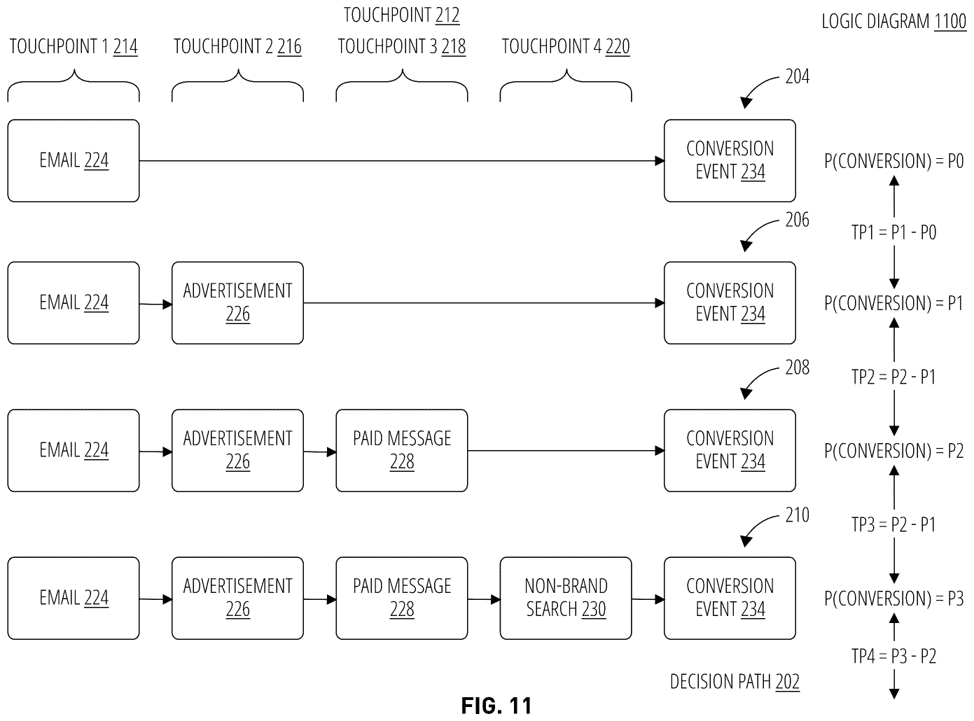

FIG. 11 illustrates a logic diagram 1100. The logic diagram 1100 is an example of inferencing operations for the advanced attribution model 308.

Once the advanced attribution model 400 has been trained, the trained model is ready to begin inferencing operations. The advanced attribution model 400 computes contributions of each touchpoint 212 for use in attribution tasks. There are two possible techniques for obtaining these contributions: (1) internal computation; and (2) external computation.

In internal computation, the weights come directly from the advanced attribution model 308 in the form of touchpoint contribution values 432. For internal computation, the advanced attribution model 308 utilizes a direct output of the attention layer 422 as the weights for each touchpoint 212 in the decision path 202. In the attention matrix, the shape is Timesteps×Timesteps. The advanced attribution model 308 performs a column-wise sum which yields a cumulative attention given to each time step by the model. These values are normalized such that they total to 1.0 across the entire decision path 202. The intuition here is that matching the touchpoint weighting used by the advanced attribution model 308 when it makes its conversion prediction.

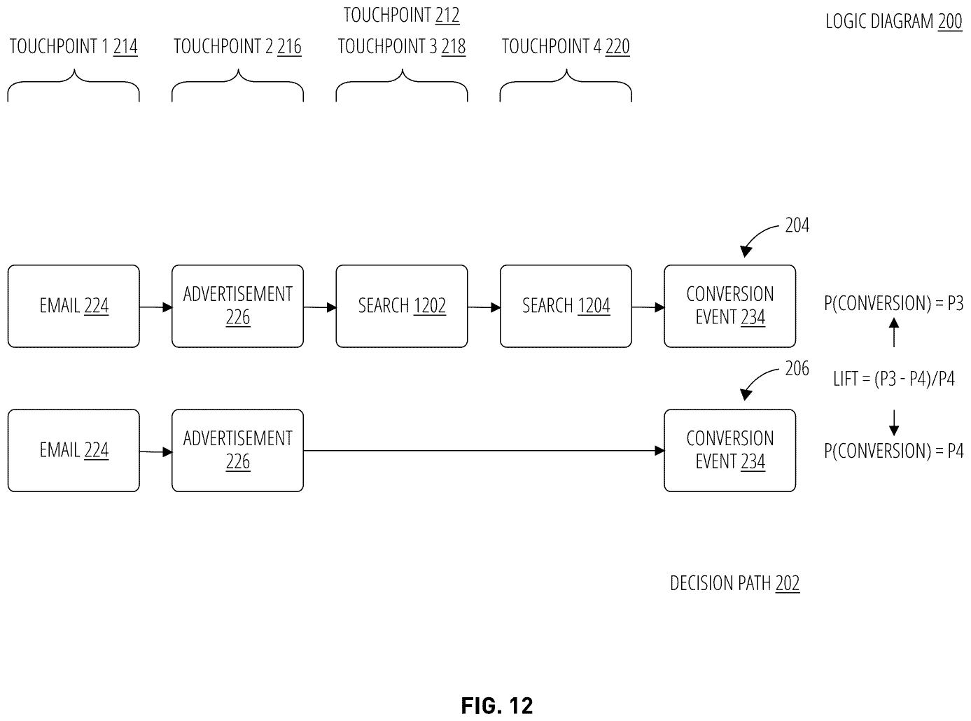

In external computation, the weights come from post-modeling inference. For external computation, the advanced attribution model 308 implements an incremental attribution technique or a lift calculation technique. The logic diagram 1100 illustrates an example of the incremental attribution technique. The lift calculation technique is described with reference to FIG. 12.

For external computation using the incremental attribution technique, the advanced attribution model 308 computes a probability of conversion while iteratively stepping through each time step of the decision path 202. The decision path 202 is built up step by step and the advanced attribution model 308 computes a new probability of conversion at each time step. A delta between each time step represents an estimated contribution of that marketing action. The deltas are normalized so that they add up to 1.0 and are interpreted as the weight of each touchpoint 212.

As depicted in logic diagram 1100, a decision path 202 comprises touchpoint 1 214, touchpoint 2 216, touchpoint 3 218, and touchpoint 4 220. Examples for the touchpoint 1 214, touchpoint 2 216, touchpoint 3 218, and touchpoint 4 220 comprise an email 224, advertisement 226, paid message 228, and non-brand search 230, respectively. The decision path 202 ends in a conversion event 234.

At time step 1, the advanced attribution model 400 computes a probability of conversion for the email 224 as P(Conversion)=P0. At time step 2, the advanced attribution model 308 computes a probability of conversion for the email 224 and the advertisement 226 as P(Conversion)=P1. At time step 3, the advanced attribution model 308 computes a probability of conversion for the email 224, the advertisement 226, and the paid message 228 as P(Conversion)=P2. At time step 4, the advanced attribution model 308 computes a probability of conversion for the email 224, the advertisement 226, the paid message 228, and the non-brand search 230 as P(Conversion)=P3.

A delta between each time step 1, 2, 3 and 4 represents an estimated contribution of that marketing action. The deltas are normalized so that they add up to 1.0 and are interpreted as the weight of each touchpoint 212. For example, the weight for touchpoint 1 214 comprising the email 224 is TP1=P1−P0, the weight for touchpoint 2 216 comprising the advertisement 226 is TP2=P2−P1, the weight for touchpoint 3 218 comprising the paid message 228 is TP3=P2−P1, and the weight for touchpoint 4 220 comprising the non-brand search 230 is TP4=P3−P2.

FIG. 12 illustrates a logic diagram 1200. The logic diagram 1200 illustrates an example of the lift calculation technique using the advanced attribution model 308.

For touchpoint lift calculations, the advanced attribution model 308 computes a probability of conversion while removing multiple touchpoints 212 simultaneously in the decision path 202. For example, the advanced attribution model 308 computes an overall impact of “Paid Search” channels by removing all “Paid Search” touchpoints 212. This simulated decision path 202 is compared with the original decision path 202 and a change in probability is expressed as a ratio. This calculation is performed at various granularities such as marketing channels or individual campaigns. This calculation more closely approximates the design of an A/B test.

As depicted in logic diagram 1200, a decision path 1 204 comprises touchpoint 1 214, touchpoint 2 216, touchpoint 3 218, and touchpoint 4 220. Examples for the touchpoint 1 214, touchpoint 2 216, touchpoint 3 218, and touchpoint 4 220 comprise an email 224, advertisement 226, a search 1202, and a search 1204, respectively. The decision path 1 204 ends in a conversion event 234.

The advanced attribution model 308 computes a probability of conversion for the decision path 1 204 as P(Conversion)=P3. The advanced attribution model 308 removes multiple touchpoints 212 simultaneously in the decision path 1 204. For example, the advanced attribution model 308 computes an overall impact of “Paid Search” channels by removing the search 1202 of touchpoint 3 218 and the search 1204 of touchpoint 4 220 from the decision path 1 204 to form a decision path 2 206. The advanced attribution model 308 computes a probability of conversion for the simulated decision path 2 206 as P(Conversion)=P4. The simulated decision path 2 206 is compared with the original decision path 1 204 and a change in probability is expressed as a ratio, such as Lift=(P3−P4)/P4. This calculation is performed at various granularities such as marketing channels or individual campaigns.

Some embodiments improve on the advanced attribution model 308 using a number of model refinement techniques, such as path re-weighting, unbiased estimation, counterfactual path generation, and modified attribution/life calculations.

For path re-weighting, in some cases, the observational data is heavily biased and may impact the ability for the model to make causal inferences. Embodiments may solve this problem using a variational recurrent auto encoder (VRAE) for the purpose of learning the latent distributions of sequences to then correct for sampling bias. Similar to inverse probability weighting (IPW), a weight is generated per path to rebalance the data during training. To obtain this weight, the advanced attribution model 308 uses the VRAE to encode all existing paths into a feature vector. The advanced attribution model 308 then uses a decoder to create synthetic paths by sampling from the normal distribution. Each path is joined with member embedding 910 and company embedding 912, and a lightweight binary classification model 410 is used to determine the probability P that a path is associated L with that member m and company c. The density ratio estimation is computed using P(L=0|m, c)/P(L=1|m, c). These values can be used as sample weights during model training.

For unbiased estimation, it is noted that time confounders can impact the casual aspect of modeling in this domain. The advanced attribution model 308 can modify sequence training to prevent the advanced attribution model 308 from learning to predict the next time step. By using a gradient reversal layer, the advanced attribution model 308 intentionally performs poorly at this task. However, minimizing final binary cross-entropy (BCE) loss is still maintained as an optimization goal. Therefore, the advanced attribution model 308 obtains a sequence model that is not good at predicting treatment (e.g., a next marketing action) but can still use the representation to accurately predict the final outcome.

For counterfactual path generation, it is noted that leaving out one or more touchpoints 212 in the decision path 202 is not an optimal approach to measuring contributions and lift. The complicating issue is that each event in a sequence is not independent of prior events. A simplified example is that the click of an advertisement cannot occur before it was impressed on an individual. Creating a sequence which only has click events would therefore not be possible. Additional biases in paths exist upon examination of how a user may interact with a website. It is not expected for a user to jump around a site at random, and therefore some actions are likely to follow other actions. This can be generalized to a Markov transition matrix where for any two touchpoints p, some will always be exactly 0, others near 0, and the remaining some value >0. The advanced attribution model 308 can create synthetic counterfactuals by using data across paths for like members. For example, if two similar members have similar paths up to a point in time, the advanced attribution model 308 can truncate one member's path up to the touchpoint being measured and then substitute their outcome with the other observed counterfactual.

For modified attribution/lift calculations, it is noted that some simplifying assumptions are made for attribution calculations. The incremental approach ignores non-linear changes or the effect of losing an entire channel in the sequence. The lift approach is only done for some cuts and is an all-or-nothing approach for that cut. Also, there are assumptions that touchpoints 212 are independent of each other when this is untrue in reality. Ideally, the counterfactual would be measured as closely to an A/B test as possible where a specific marketing campaign never existed. One approach for the advanced attribution model 308 is using Shapley values to compute the contribution of each simulated path. Incremental calculation of contribution of each touchpoint described above can be thought of as an approximation of the game theoretic way of calculating each player's (touchpoint's) contribution to a conversion event 234, which is referred to as Shapley values. The calculation of Shapley value of a touchpoint is numerically very expensive, but there are Monte Carlo approximations developed. The advanced attribution model 308 may implement this approximation and analyze how the attributions change compared to the other methods described above.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

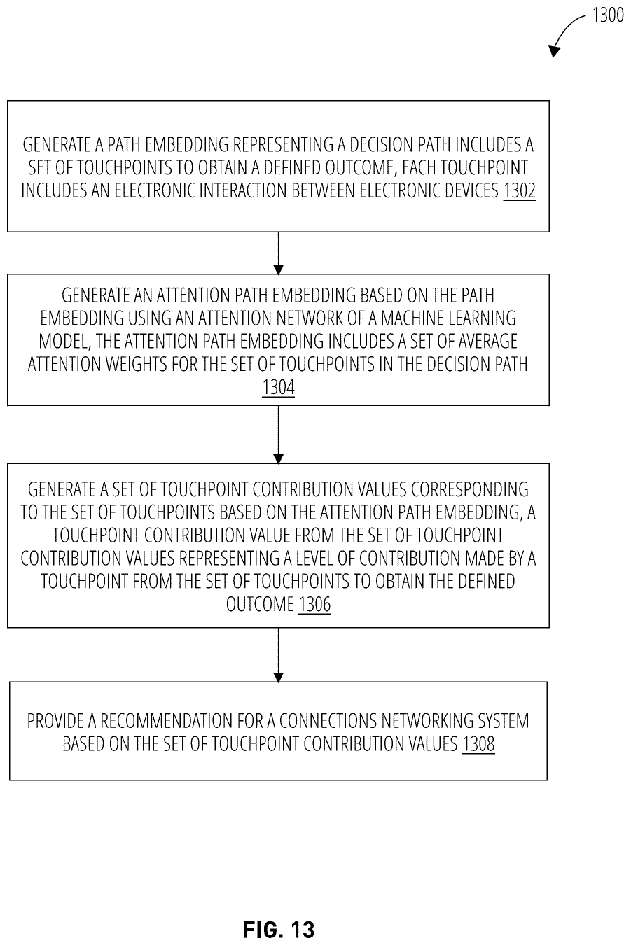

FIG. 13 illustrates an embodiment of a logic flow 1300. The logic flow 1300 is representative of some or all of the operations executed by one or more embodiments described herein. For example, the logic flow 1300 includes some or all of the operations performed by devices or entities within the AI system 110 and/or the advanced attribution model 308. In one embodiment, the logic flow 1300 is implemented as instructions stored on a non-transitory computer-readable storage medium, such as the storage medium 1422, that when executed by the processing circuitry 1418 causes the processing circuitry 1418 to perform the described operations. The storage medium 1422 and processing circuitry 1418 may be co-located, or the instructions may be stored remotely from the processing circuitry 1418. Collectively, the storage medium 1422 and the processing circuitry 1418 may form a system.

In block 1302, the logic flow 1300 generates a path embedding representing a decision path includes a set of touchpoints to obtain a defined outcome, each touchpoint includes an electronic interaction between electronic devices. In block 1304, the logic flow 1300 generates an attention path embedding based on the path embedding using an attention network of a machine learning model, the attention path embedding includes a set of aggregated attention weights for the set of touchpoints in the decision path. In block 1306, the logic flow 1300 generates a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome. In block 1308, the logic flow 1300 provides a recommendation for a connections networking system based on the set of touchpoint contribution values.

By way of example, the electronic device 302 comprises memory to store instructions for the advanced attribution model 308 that when executed by circuitry causes the advanced attribution model 308 to generate a path embedding 310 representing a decision path 202 comprising a set of touchpoints 212 to obtain a defined outcome, such as conversion event 234. Each touchpoint 212 comprises an electronic interaction between electronic devices, such as client system 122 and the server system 128 and/or the connections networking system 102. The advanced attribution model 308 generates an attention path embedding 314 based on the path embedding 310 using an attention network 312, such as attention layer 422. In one embodiment, for example, the attention path embedding 314 comprises a set of aggregated attention weights 712 for the set of touchpoints 212 in the decision path 202. The advanced attribution model 308 generates a set of touchpoint contribution values 304 corresponding to the set of touchpoints 212 based on the attention path embedding 314 using an allocation network 316, such as a classification layer 430. A touchpoint contribution value from the set of touchpoint contribution values 304 represents a level of contribution made by a touchpoint 212 from the set of touchpoints 212 to obtain the defined outcome, such as conversion event 234. The model manager 306 then passes the touchpoint contribution values 304 to a management device 438 for use in various downstream tasks, such as providing a recommendation for the connections networking system 102 based on the touchpoint contribution values 304.

In one embodiment, for example, the logic flow 1300 may generate a modified path embedding 420 based on the path embedding 310 using a path interpolation layer 418 of the advanced attribution model 308, the modified path embedding 420 to include the set of touchpoints 212 and an unobserved touchpoint 212 interpolated from the set of touchpoints 212 by the path interpolation layer 418. The attention network 312 generates the attention path embedding 314 based on the modified path embedding 420.

In one embodiment, for example, the logic flow 1300 may generate a positional encoded path 608 using a positional encoding layer 602 of the advanced attribution model 308, the positional encoded path 608 to include position information 610 associated with the set of touchpoints 212 to allow for order differentiation between touchpoints 212 in the set of touchpoints 212. The attention network 312 generates the attention path embedding 314 based on the positional encoded path 608.

In one embodiment, for example, the logic flow 1300 may generate the average set of attention weights 1732 for the set of touchpoints 212 in the decision path 202 using a set of self-attention structures 716 for a multi-head model 714 of the advanced attribution model 308, each self-attention structure to generate a set of attention weights, and an aggregation layer 710 to aggregate each set of attention weights to form the set of aggregated attention weights 712. For example, the multi-head model 714 may comprise a plurality of self-attention structures 716 including self-attention structure 1 702, self-attention structure 2 704, self-attention structure 3 706, and self-attention structure S 708 each generating attention weights 718, attention weights 720, attention weights 722, and attention weights 724, respectively. The aggregation layer 710 receives the attention weights 718, attention weights 720, attention weights 722, and attention weights 724, and outputs an average for the individual attentions weights as the aggregated attention weights 712.

In one embodiment, for example, the logic flow 1300 may generate the set of aggregated attention weights 712 for the set of touchpoints 212 in the decision path 202 using a transformer model 802. The transformer model 802 includes a plurality of transformer blocks, such as transformer block 2 804 and transformer block 1 808, where each transformer block includes a multi-head model 714 that includes multiple self-attention structures 716, each transformer block to generate a set of attention weights, and an aggregation layer to aggregate each set of attention weights to form the set of aggregated attention weights 712. For example, the multi-head model 714 of the transformer block 2 804 generates a set of attention weights 816 that are processed by the transformer sub-blocks 806 of the transformer block 2 804 and passed to the transformer block 1 808. The multi-head model 714 of the transformer block 1 808 receives as input the attention weights 816 and the positional encoded path 608, and it generates a set of attention weights 818 that are processed by the transformer sub-blocks 806 of the 808. The aggregation layer 810 aggregates the attention weights 816 and attention weights 818 and it outputs the set of aggregated attention weights 712.

In one embodiment, for example, the logic flow 1300 may generate a context path embedding 428 based on the attention path embedding 314 and a contextual embedding 908 using a concatenation layer 904 of the advanced attribution model 308, the contextual embedding 908 to include a member embedding 910, a company embedding 912, and/or a campaign embedding 914. The allocation network 316, such as classification layer 430, generates the set of touchpoint contribution values 304 corresponding to the set of touchpoints 212 based on the context path embedding 428.

In one embodiment, for example, the logic flow 1300 may generate a set of calibrated values 436 for the set of touchpoint contribution values 304 using a calibration layer 434 of the advanced attribution model 308, the calibration layer 434 using a secondary mix model 1002. Other technical features may be readily apparent to one skilled in the art from the figures, descriptions, and claims.

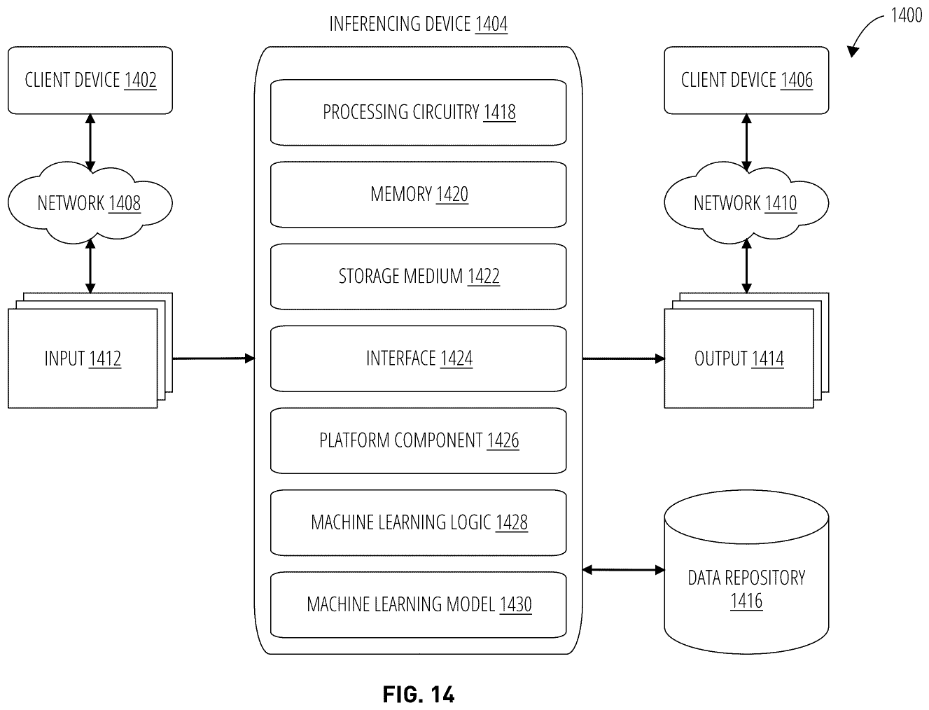

FIG. 14 illustrates an embodiment of a system 1400. The system 1400 is suitable for implementing one or more embodiments as described herein. In one embodiment, for example, the system 1400 is system suitable for implementing the AI system 110 or one or more ML models 138, such as the advanced attribution model 308, for example. For instance, in marketing attribution, the advanced attribution model 308 seeks to quantify what impact a marketing interaction had on an observed business outcome. These outcomes are referred to as conversion events and may comprise actions such as visiting a specific web page, purchasing a product, or registering a new account. There are several approaches to modeling the impact of these interactions on conversions. Top-down methodologies like media mix modeling (MMM) use aggregate time-series data to model how the level of exposures from a marketing channel contribute to the observed conversion outcomes. Bottom-up approaches like multi-touch attribution (MTA) use identifiers to construct individual journeys and assign credit to those touches. The advanced attribution model 308 may implement a MMM approach, an MTA approach, or a combination of the MMM approach and the MTA approach. Embodiments are not limited in this context.

The system 1400 comprises a set of M devices, where M is any positive integer. FIG. 14 depicts three devices (M=3), including a client device 1402, an inferencing device 1404, and a client device 1406. The inferencing device 1404 communicates information with the client device 1402 and the client device 1406 over a network 1408 and a network 1410, respectively. The information may include input 1412 from the client device 1402 and output 1414 to the client device 1406, or vice-versa. In one alternative, the input 1412 and the output 1414 are communicated between the same client device 1402 or client device 1406. In another alternative, the input 1412 and the output 1414 are stored in a data repository 1416. In yet another alternative, the input 1412 and the output 1414 are communicated via a platform component 1426 of the inferencing device 1404, such as an input/output (I/O) device (e.g., a touchscreen, a microphone, a speaker, etc.).

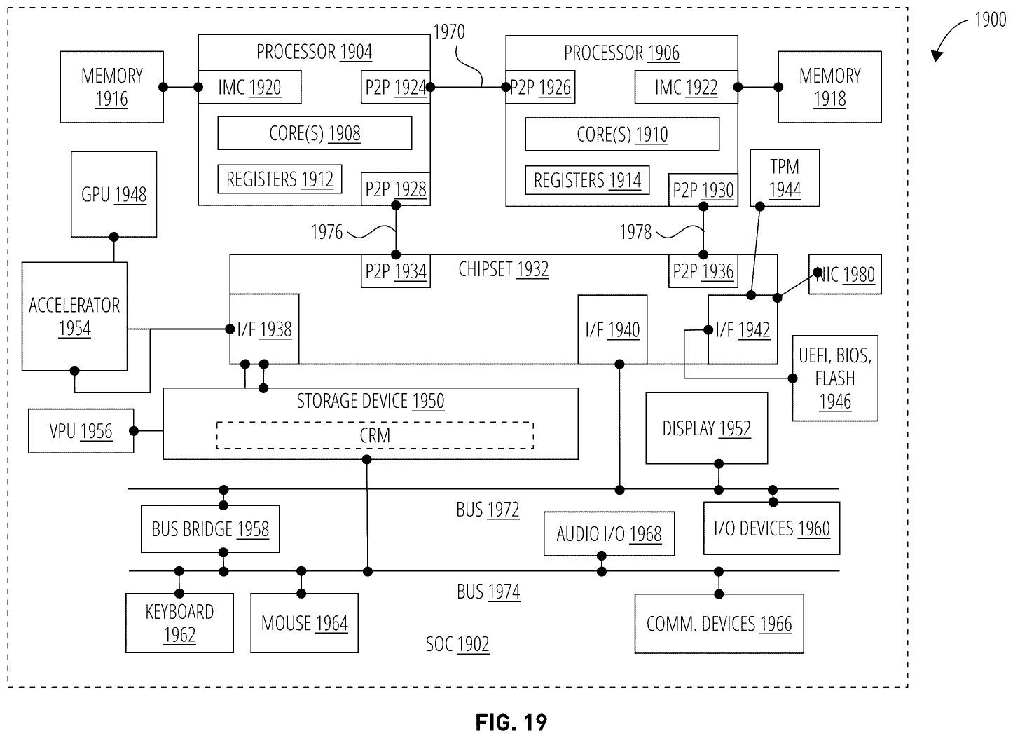

As depicted in FIG. 14, the inferencing device 1404 includes processing circuitry 1418, a memory 1420, a storage medium 1422, an interface 1424, a platform component 1426, ML logic 1428, and an ML model 1430. In some implementations, the inferencing device 1404 includes other components or devices as well. Examples for software elements and hardware elements of the inferencing device 1404 are described in more detail with reference to a computing architecture 1900 as depicted in FIG. 19. Embodiments are not limited to these examples.

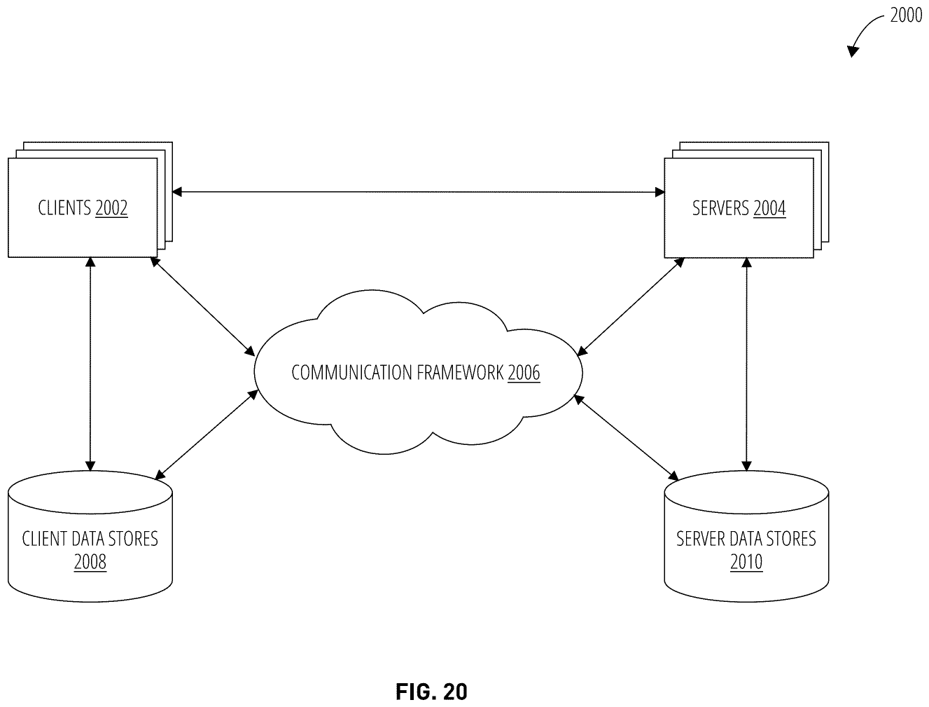

The inferencing device 1404 is generally arranged to receive an input 1412, process the input 1412 via one or more AI/ML techniques, and send an output 1414. The inferencing device 1404 receives the input 1412 from the client device 1402 via the network 1408, the client device 1406 via the network 1410, the platform component 1426 (e.g., a touchscreen as a text command or microphone as a voice command), the memory 1420, the storage medium 1422 or the data repository 1416. The inferencing device 1404 sends the output 1414 to the client device 1402 via the network 1408, the client device 1406 via the network 1410, the platform component 1426 (e.g., a touchscreen to present text, graphic or video information or speaker to reproduce audio information), the memory 1420, the storage medium 1422 or the data repository 1416. Examples for the software elements and hardware elements of the network 1408 and the network 1410 are described in more detail with reference to a communications architecture 2000 as depicted in FIG. 20. Embodiments are not limited to these examples.

The inferencing device 1404 includes ML logic 1428 and an ML model 1430 to implement various AI/ML techniques for various AI/ML tasks. The ML logic 1428 receives the input 1412, and processes the input 1412 using the ML model 1430. The ML model 1430 performs inferencing operations to generate an inference for a specific task from the input 1412. In some cases, the inference is part of the output 1414. The output 1414 is used by the client device 1402, the inferencing device 1404, or the client device 1406 to perform subsequent actions in response to the output 1414.

In various embodiments, the ML model 1430 is a trained ML model 1430 using a set of training operations. An example of training operations to train the ML model 1430 is described with reference to FIG. 15.

FIG. 15 illustrates an apparatus 1500. The apparatus 1500 depicts a training device 1514 suitable to generate a trained ML model 1430 for the inferencing device 1404 of the system 1400. As depicted in FIG. 15, the training device 1514 includes a processing circuitry 1516 and a set of ML components 1510 to support various AI/ML techniques, such as a data collector 1502, a model trainer 1504, a model evaluator 1506 and a model inferencer 1508.

In general, the data collector 1502 collects data 1512 from one or more data sources to use as training data for the ML model 1430. The data collector 1502 collects different types of data 1512, such as text information, audio information, image information, video information, graphic information, and so forth. The model trainer 1504 receives as input the collected data and uses a portion of the collected data as test data for an AI/ML algorithm to train the ML model 1430. The model evaluator 1506 evaluates and improves the trained ML model 1430 using a portion of the collected data as test data to test the ML model 1430. The model evaluator 1506 also uses feedback information from the deployed ML model 1430. The model inferencer 1508 implements the trained ML model 1430 to receive as input new unseen data, generate one or more inferences on the new data, and output a result such as an alert, a recommendation or other post-solution activity.

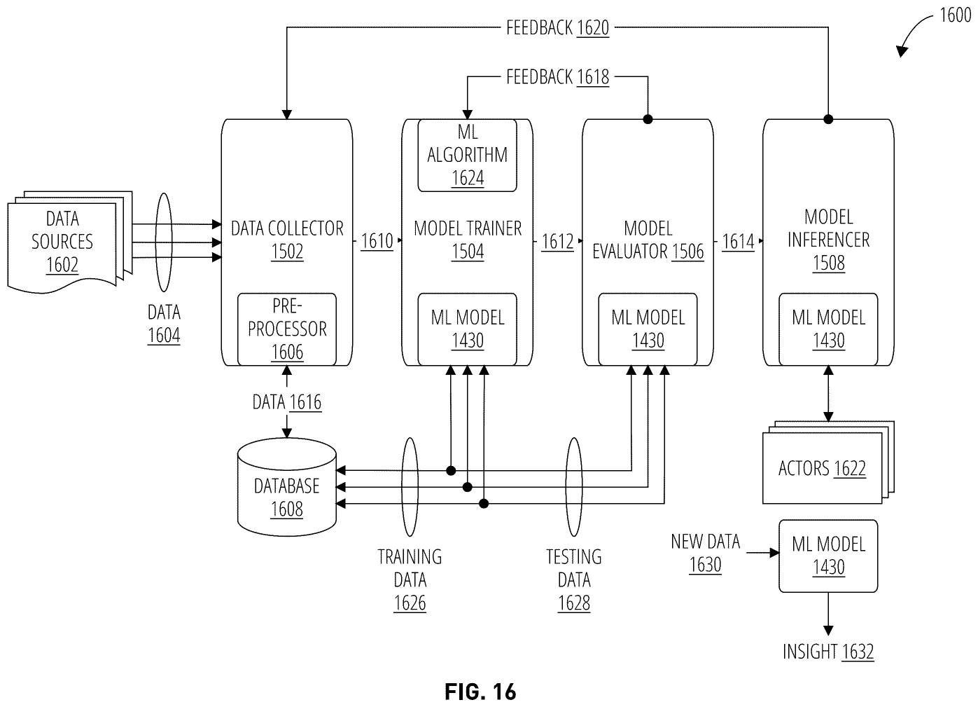

An exemplary AI/ML architecture for the ML components 1510 is described in more detail with reference to FIG. 16.

FIG. 16 illustrates an artificial intelligence architecture 1600 suitable for use by the training device 1514 to generate the ML model 1430 for deployment by the inferencing device 1404. The artificial intelligence architecture 1600 is an example of a system suitable for implementing various AI techniques and/or ML techniques to perform various inferencing tasks on behalf of the various devices of the system 1400.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1600 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1430, evaluate performance of the trained ML model 1430, and deploy the tested ML model 1430 as the trained ML model 1430 in a production environment, and continuously monitor and maintain it.

The ML model 1430 is a mathematical construct used to predict outcomes based on a set of input data. The ML model 1430 is trained using large volumes of training data 1626, and it can recognize patterns and trends in the training data 1626 to make accurate predictions. The ML model 1430 is derived from an ML algorithm 1624 (e.g., a neural network, decision tree, support vector machine, etc.). A data set is fed into the ML algorithm 1624 which trains an ML model 1430 to “learn” a function that produces mappings between a set of inputs and a set of outputs with a reasonably high accuracy. Given a sufficiently large enough set of inputs and outputs, the ML algorithm 1624 finds the function for a given task. This function may even be able to produce the correct output for input that it has not seen during training. A data scientist prepares the mappings, selects and tunes the ML algorithm 1624, and evaluates the resulting model performance. Once the ML logic 1428 is sufficiently accurate on test data, it can be deployed for production use.

The ML algorithm 1624 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1624 of the artificial intelligence architecture 1600 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 16, the artificial intelligence architecture 1600 includes a set of data sources 1602 to source data 1604 for the artificial intelligence architecture 1600. Data sources 1602 may comprise any device capable generating, processing, storing or managing data 1604 suitable for a ML system. Examples of data sources 1602 include without limitation databases, web scraping, sensors and Internet of Things (IoT) devices, image and video cameras, audio devices, text generators, publicly available databases, private databases, and many other data sources 1602. The data sources 1602 may be remote from the artificial intelligence architecture 1600 and accessed via a network, local to the artificial intelligence architecture 1600 an accessed via a network interface, or may be a combination of local and remote data sources 1602.

The data sources 1602 source difference types of data 1604. By way of example and not limitation, the data 1604 includes structured data from relational databases, such as customer profiles, transaction histories, or product inventories. The data 1604 includes unstructured data from websites such as customer reviews, news articles, social media posts, or product specifications. The data 1604 includes data from temperature sensors, motion detectors, and smart home appliances. The data 1604 includes image data from medical images, security footage, or satellite images. The data 1604 includes audio data from speech recognition, music recognition, or call centers. The data 1604 includes text data from emails, chat logs, customer feedback, news articles or social media posts. The data 1604 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1604 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1602 are communicatively coupled to a data collector 1502. The data collector 1502 gathers relevant data 1604 from the data sources 1602. Once collected, the data collector 1502 may use a pre-processor 1606 to make the data 1604 suitable for analysis. This involves data cleaning, transformation, and feature engineering. Data preprocessing is a critical step in ML as it directly impacts the accuracy and effectiveness of the ML model 1430. The pre-processor 1606 receives the data 1604 as input, processes the data 1604, and outputs pre-processed data 1616 for storage in a database 1608. Examples for the database 1608 includes a hard drive, solid state storage, and/or random access memory (RAM).

The data collector 1502 is communicatively coupled to a model trainer 1504. The model trainer 1504 performs AI/ML model training, validation, and testing which may generate model performance metrics as part of the model testing procedure. The model trainer 1504 receives the pre-processed data 1616 as input 1610 or via the database 1608. The model trainer 1504 implements a suitable ML algorithm 1624 to train an ML model 1430 on a set of training data 1626 from the pre-processed data 1616. The training process involves feeding the pre-processed data 1616 into the ML algorithm 1624 to produce or optimize an ML model 1430. The training process adjusts its parameters until it achieves an initial level of satisfactory performance.

The model trainer 1504 is communicatively coupled to a model evaluator 1506. After an ML model 1430 is trained, the ML model 1430 needs to be evaluated to assess its performance. This is done using various metrics such as accuracy, precision, recall, and F1 score. The model trainer 1504 outputs the ML model 1430, which is received as input 1610 or from the database 1608. The model evaluator 1506 receives the ML model 1430 as input 1612, and it initiates an evaluation process to measure performance of the ML model 1430. The evaluation process includes providing feedback 1618 to the model trainer 1504. The model trainer 1504 re-trains the ML model 1430 to improve performance in an iterative manner.

The model evaluator 1506 is communicatively coupled to a model inferencer 1508. The model inferencer 1508 provides AI/ML model inference output (e.g., inferences, predictions or decisions). Once the ML model 1430 is trained and evaluated, it is deployed in a production environment where it is used to make predictions on new data. The model inferencer 1508 receives the evaluated ML model 1430 as input 1614. The model inferencer 1508 uses the evaluated ML model 1430 to produce insights or predictions on real data, which is deployed as a final production ML model 1430. The inference output of the ML model 1430 is use case specific. The model inferencer 1508 also performs model monitoring and maintenance, which involves continuously monitoring performance of the ML model 1430 in the production environment and making any necessary updates or modifications to maintain its accuracy and effectiveness. The model inferencer 1508 provides feedback 1618 to the data collector 1502 to train or re-train the ML model 1430. The feedback 1618 includes model performance feedback information, which is used for monitoring and improving performance of the ML model 1430.

Some or all of the model inferencer 1508 is implemented by various actors 1622 in the artificial intelligence architecture 1600, including the ML model 1430 of the inferencing device 1404, for example. The actors 1622 use the deployed ML model 1430 on new data to make inferences or predictions for a given task, and output an insight 1632. The actors 1622 implement the model inferencer 1508 locally, or remotely receives outputs from the model inferencer 1508 in a distributed computing manner. The actors 1622 trigger actions directed to other entities or to itself. The actors 1622 provide feedback 1620 to the data collector 1502 via the model inferencer 1508. The feedback 1620 comprise data needed to derive training data, inference data or to monitor the performance of the ML model 1430 and its impact to the network through updating of key performance indicators (KPIs) and performance counters.

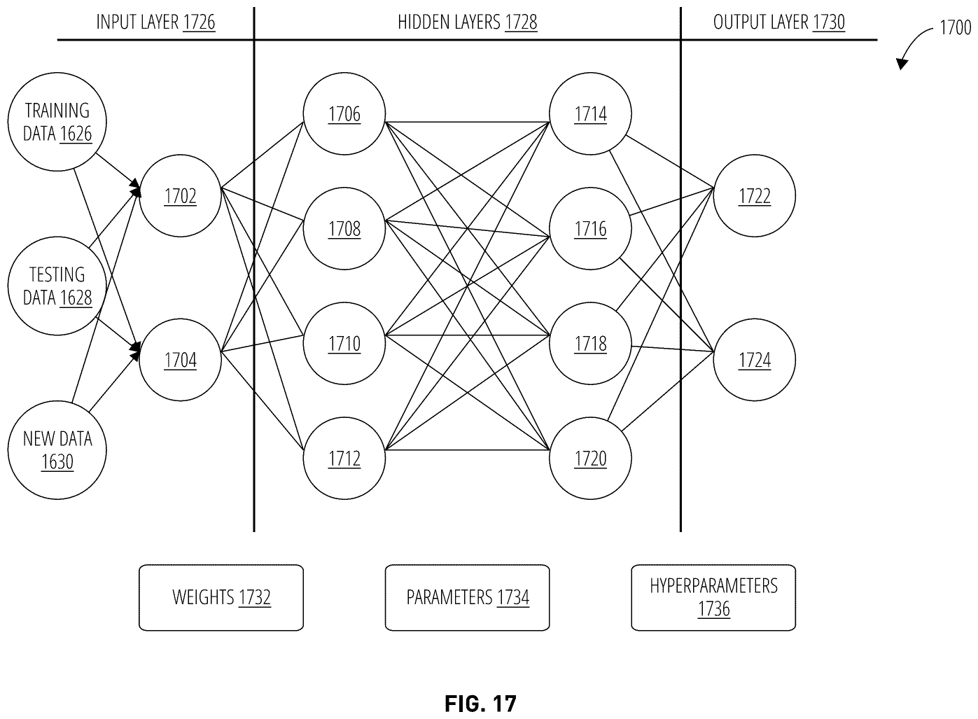

As previously described with reference to FIGS. 1, 2, the systems 1400, 1500 implement some or all of the artificial intelligence architecture 1600 to support various use cases and solutions for various AI/ML tasks. In various embodiments, the training device 1514 of the apparatus 1500 uses the artificial intelligence architecture 1600 to generate and train the ML model 1430 for use by the inferencing device 1404 for the system 1400. In one embodiment, for example, the training device 1514 may train the ML model 1430 as a neural network, as described in more detail with reference to FIG. 17. Other use cases and solutions for AI/ML are possible as well, and embodiments are not limited in this context.

FIG. 17 illustrates an embodiment of an artificial neural network 1700. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1700 comprises multiple node layers, containing an input layer 1726, one or more hidden layers 1728, and an output layer 1730. Each layer comprises one or more nodes, such as nodes 1702 to 1724. As depicted in FIG. 17, for example, the input layer 1726 has nodes 1702, 1704. The artificial neural network 1700 has two hidden layers 1728, with a first hidden layer having nodes 1706, 1708, 1710 and 1712, and a second hidden layer having nodes 1714, 1716, 1718 and 1720. The artificial neural network 1700 has an output layer 1730 with nodes 1722, 1724. Each node 1702 to 1724 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1700 relies on training data 1626 to learn and improve accuracy over time. However, once the artificial neural network 1700 is fine-tuned for accuracy, and tested on testing data 1628, the artificial neural network 1700 is ready to classify and cluster new data 1630 at a high velocity. Tasks in speech recognition or image recognition can take minutes versus hours when compared to the manual identification by human experts.

Each individual node 1702 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x3 + bias \qquad EQUATION ( 1 )$$

$$output = f ( x ) = 1 if \sum w 1 x 1 + b >= 0 ; 0 if \sum w 1 x 1 + b < 0$$

Once an input layer 1726 is determined, a set of weights 1732 are assigned. The weights 1732 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1700 as a feedforward network.

In one embodiment, the artificial neural network 1700 leverages sigmoid neurons, which are distinguished by having values between 0 and 1. Since the artificial neural network 1700 behaves similarly to a decision tree, cascading data from one node to another, having x values between 0 and 1 will reduce the impact of any given change of a single variable on the output of any given node, and subsequently, the output of the artificial neural network 1700.

The artificial neural network 1700 has many practical use cases, like image recognition, speech recognition, text recognition or classification. The artificial neural network 1700 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( {\hat{y}}_{i} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1734 of the model adjust to gradually converge at the minimum.

In one embodiment, the artificial neural network 1700 is feedforward, meaning it flows in one direction only, from input to output. In one embodiment, the artificial neural network 1700 uses backpropagation. Backpropagation is when the artificial neural network 1700 moves in the opposite direction from output to input. Backpropagation allows calculation and attribution of errors associated with each neuron 1702 to 1724, thereby allowing adjustment to fit the parameters 1734 of the ML model 1430 appropriately.

The artificial neural network 1700 is implemented as different neural networks depending on a given task. Neural networks are classified into different types, which are used for different purposes. In one embodiment, the artificial neural network 1700 is implemented as a feedforward neural network, or multi-layer perceptrons (MLPs), comprised of an input layer 1726, hidden layers 1728, and an output layer 1730. While these neural networks are also commonly referred to as MLPs, they are actually comprised of sigmoid neurons, not perceptrons, as most real-world problems are nonlinear. Trained data 1604 usually is fed into these models to train them, and they are the foundation for computer vision, natural language processing, and other neural networks. In one embodiment, the artificial neural network 1700 is implemented as a convolutional neural network (CNN). A CNN is similar to feed forward networks, but usually utilized for image recognition, pattern recognition, and/or computer vision. These networks harness principles from linear algebra, particularly matrix multiplication, to identify patterns within an image. In one embodiment, the artificial neural network 1700 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1700 is implemented as any type of neural network suitable for a given operational task of system 1400, and the MLP, CNN, and RNN are merely a few examples. Embodiments are not limited in this context.

The artificial neural network 1700 includes a set of associated parameters 1734. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1700 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1736. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

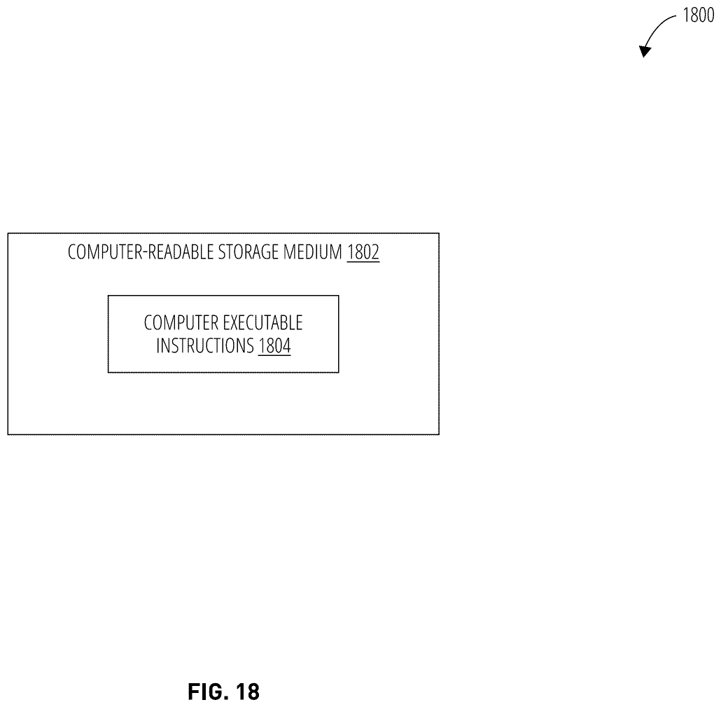

FIG. 18 illustrates an apparatus 1800. Apparatus 1800 comprises any non-transitory computer-readable storage medium 1802 or machine-readable storage medium, such as an optical, magnetic or semiconductor storage medium. In various embodiments, apparatus 1800 comprises an article of manufacture or a product. In some embodiments, the computer-readable storage medium 1802 stores computer executable instructions with which one or more processing devices or processing circuitry can execute. For example, computer executable instructions 1804 includes instructions to implement operations described with respect to any logic flows described herein. Examples of computer-readable storage medium 1802 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1804 include any suitable type of code, such as source code, compiled code, interpreted code, executable code, static code, dynamic code, object-oriented code, visual code, and the like.

FIG. 19 illustrates an embodiment of a computing architecture 1900. Computing architecture 1900 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1900 has a single processor with one core or more than one processor. Note that the term “processor” refers to a processor with a single core or a processor package with multiple processor cores. In at least one embodiment, the computing architecture 1900 is representative of the components of the system 1400. More generally, the computing architecture 1900 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1900. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 19, computing architecture 1900 comprises a system-on-chip (SoC) 1902 for mounting platform components. System-on-chip (SoC) 1902 is a point-to-point (P2P) interconnect platform that includes a first processor 1904 and a second processor 1906 coupled via a point-to-point interconnect 1970 such as an Ultra Path Interconnect (UPI). In other embodiments, the computing architecture 1900 is another bus architecture, such as a multi-drop bus. Furthermore, each of processor 1904 and processor 1906 are processor packages with multiple processor cores including core(s) 1908 and core(s) 1910, respectively. While the computing architecture 1900 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1904 and chipset 1932. Some platforms include additional components and some platforms include sockets to mount the processors and/or the chipset. Furthermore, some platforms do not have sockets (e.g. SoC, or the like). Although depicted as a SoC 1902, one or more of the components of the SoC 1902 are included in a single die package, a multi-chip module (MCM), a multi-die package, a chiplet, a bridge, and/or an interposer. Therefore, embodiments are not limited to a SoC.

The processor 1904 and processor 1906 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1904 and/or processor 1906. Additionally, the processor 1904 need not be identical to processor 1906.

Processor 1904 includes an integrated memory controller (IMC) 1920 and point-to-point (P2P) interface 1924 and P2P interface 1928. Similarly, the processor 1906 includes an IMC 1922 as well as P2P interface 1926 and P2P interface 1930. IMC 1920 and IMC 1922 couple the processor 1904 and processor 1906, respectively, to respective memories (e.g., memory 1916 and memory 1918). Memory 1916 and memory 1918 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1916 and the memory 1918 locally attach to the respective processors (i.e., processor 1904 and processor 1906). In other embodiments, the main memory couple with the processors via a bus and shared memory hub. Processor 1904 includes registers 1912 and processor 1906 includes registers 1914.

Computing architecture 1900 includes chipset 1932 coupled to processor 1904 and processor 1906. Furthermore, chipset 1932 are coupled to storage device 1950, for example, via an interface (I/F) 1938. The I/F 1938 may be, for example, a Peripheral Component Interconnect-enhanced (PCIe) interface, a Compute Express Link® (CXL) interface, or a Universal Chiplet Interconnect Express (UCIe) interface. Storage device 1950 stores instructions executable by circuitry of computing architecture 1900 (e.g., processor 1904, processor 1906, GPU 1948, accelerator 1954, vision processing unit 1956, or the like). For example, storage device 1950 can store instructions for the client device 1402, the client device 1406, the inferencing device 1404, the training device 1514, or the like.

Processor 1904 couples to the chipset 1932 via P2P interface 1928 and P2P 1934 while processor 1906 couples to the chipset 1932 via P2P interface 1930 and P2P 1936. Direct media interface (DMI) 1976 and DMI 1978 couple the P2P interface 1928 and the P2P 1934 and the P2P interface 1930 and P2P 1936, respectively. DMI 1976 and DMI 1978 is a high-speed interconnect that facilitates, e.g., eight Giga Transfers per second (GT/s) such as DMI 3.0. In other embodiments, the processor 1904 and processor 1906 interconnect via a bus.

The chipset 1932 comprises a controller hub such as a platform controller hub (PCH). The chipset 1932 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1932 comprises more than one controller hub such as a chipset with a memory controller hub, a graphics controller hub, and an input/output (I/O) controller hub.

In the depicted example, chipset 1932 couples with a trusted platform module (TPM) 1944 and UEFI, BIOS, FLASH circuitry 1946 via I/F 1942. The TPM 1944 is a dedicated microcontroller designed to secure hardware by integrating cryptographic keys into devices. The UEFI, BIOS, FLASH circuitry 1946 may provide pre-boot code. The I/F 1942 may also be coupled to a network interface circuit (NIC) 1980 for connections off-chip.

Furthermore, chipset 1932 includes the I/F 1938 to couple chipset 1932 with a high-performance graphics engine, such as, graphics processing circuitry or a graphics processing unit (GPU) 1948. In other embodiments, the computing architecture 1900 includes a flexible display interface (FDI) (not shown) between the processor 1904 and/or the processor 1906 and the chipset 1932. The FDI interconnects a graphics processor core in one or more of processor 1904 and/or processor 1906 with the chipset 1932.

The computing architecture 1900 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1954 and/or vision processing unit 1956 are coupled to chipset 1932 via I/F 1938. The accelerator 1954 is representative of any type of accelerator device (e.g., a data streaming accelerator, cryptographic accelerator, cryptographic co-processor, an offload engine, etc.). One example of an accelerator 1954 is the Intel® Data Streaming Accelerator (DSA). The accelerator 1954 is a device including circuitry to accelerate copy operations, data encryption, hash value computation, data comparison operations (including comparison of data in memory 1916 and/or memory 1918), and/or data compression. Examples for the accelerator 1954 include a USB device, PCI device, PCIe device, CXL device, UCIe device, and/or an SPI device. The accelerator 1954 also includes circuitry arranged to execute machine learning (ML) related operations (e.g., training, inference, etc.) for ML models. Generally, the accelerator 1954 is specially designed to perform computationally intensive operations, such as hash value computations, comparison operations, cryptographic operations, and/or compression operations, in a manner that is more efficient than when performed by the processor 1904 or processor 1906. Because the load of the computing architecture 1900 includes hash value computations, comparison operations, cryptographic operations, and/or compression operations, the accelerator 1954 greatly increases performance of the computing architecture 1900 for these operations.

The accelerator 1954 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1954. For example, the accelerator 1954 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1954 via a non-posted write (e.g., a deferred memory write (DMWr)). One example of an instruction that atomically submits a work descriptor to the shared work queue of the accelerator 1954 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1954. The dedicated work queue may accept job submissions via commands such as the movdir64b instruction.

Various I/O devices 1960 and display 1952 couple to the bus 1972, along with a bus bridge 1958 which couples the bus 1972 to a second bus 1974 and an I/F 1940 that connects the bus 1972 with the chipset 1932. In one embodiment, the second bus 1974 is a low pin count (LPC) bus. Various input/output (I/O) devices couple to the second bus 1974 including, for example, a keyboard 1962, a mouse 1964 and communication devices 1966.

Furthermore, an audio I/O 1968 couples to second bus 1974. Many of the I/O devices 1960 and communication devices 1966 reside on the system-on-chip (SoC) 1902 while the keyboard 1962 and the mouse 1964 are add-on peripherals. In other embodiments, some or all the I/O devices 1960 and communication devices 1966 are add-on peripherals and do not reside on the system-on-chip (SoC) 1902.

FIG. 20 illustrates a block diagram of an exemplary communications architecture 2000 suitable for implementing various embodiments as previously described. The communications architecture 2000 includes various common communications elements, such as a transmitter, receiver, transceiver, radio, network interface, baseband processor, antenna, amplifiers, filters, power supplies, and so forth. The embodiments, however, are not limited to implementation by the communications architecture 2000.

As shown in FIG. 20, the communications architecture 2000 includes one or more clients 2002 and servers 2004. The clients 2002 and the servers 2004 are operatively connected to one or more respective client data stores 2008 and server data stores 2010 that can be employed to store information local to the respective clients 2002 and servers 2004, such as cookies and/or associated contextual information.

The clients 2002 and the servers 2004 communicate information between each other using a communication framework 2006. The communication framework 2006 implements any well-known communications techniques and protocols. The communication framework 2006 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 2006 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1400/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 2002 and the servers 2004. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

The following examples pertain to further embodiments, from which numerous permutations and configurations will be apparent.

An example computer-implemented method comprises generating (1320) a path embedding representing a decision path comprising a set of touchpoints to obtain a defined outcome, each touchpoint comprising an electronic interaction between electronic devices; generating (1304) an attention path embedding based on the path embedding using an attention network of a machine learning model, the attention path embedding comprising a set of aggregated attention weights for the set of touchpoints in the decision path; generating (1306) a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome; and providing a recommendation for a connections networking system based on the set of touchpoint contribution values.

Any of the previous examples for the computer-implemented method further comprising generating a modified path embedding based on the path embedding using a path interpolation layer of the machine learning model, the modified path embedding comprising the set of touchpoints and an unobserved touchpoint interpolated from the set of touchpoints by the path interpolation layer, and generating the attention path embedding based on the modified path embedding using the attention network of the machine learning model.

Any of the previous examples for the computer-implemented method further comprising generating a positional encoded path using a positional encoding layer of the machine learning model, the positional encoded path comprising position information associated with the set of touchpoints to allow for order differentiation between touchpoints in the set of touchpoints; and generating the attention path embedding based on the positional encoded path using the attention network of the machine learning model.

Any of the previous examples for the computer-implemented method further comprising generating the set of aggregated attention weights for the set of touchpoints in the decision path using a set of self-attention structures for a multi-head model of the machine learning model, each self-attention structure to generate a set of attention weights, and an aggregation layer to aggregate each set of attention weights to form the set of aggregated attention weights.

Any of the previous examples for the computer-implemented method further comprising generating the set of aggregated attention weights for the set of touchpoints in the decision path using a transformer model, the transformer model comprising a plurality of transformer blocks, each transformer block comprising a multi-head model comprising multiple self-attention structures, each transformer block to generate a set of attention weights, and an aggregation layer to aggregate each set of attention weights to form the set of aggregated attention weights.

Any of the previous examples for the computer-implemented method further comprising generating a context path embedding based on the attention path embedding and a contextual embedding using a concatenation layer of the machine learning model, the contextual embedding comprising a member embedding, a company embedding, or a campaign embedding; and generating the set of touchpoint contribution values corresponding to the set of touchpoints based on the context path embedding.

Any of the previous examples for the computer-implemented method further comprising generating a set of calibrated values for the set of touchpoint contribution values using a calibration layer of the machine learning model, the calibration layer using a secondary mix model.

An example of a computing apparatus comprising: a memory component; and circuitry coupled to the memory component, the circuitry to: generate (1302) a path embedding representing a decision path comprising a set of touchpoints to obtain a defined outcome, each touchpoint comprising an electronic interaction between electronic devices, wherein the defined outcome is a failure of security or functionality in a communications network comprising the electronic devices; generate (1304) an attention path embedding based on the path embedding using an attention network of a machine learning model, the attention path embedding comprising a set of aggregated attention weights for the set of touchpoints in the decision path; generate (1306) a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome; and provide a recommendation for a connections networking system based on the set of touchpoint contribution values, the recommendation comprising an action to mitigate future instances of the defined outcome.

Any of the previous examples for the computing apparatus further comprising the circuitry to: for each of the touchpoints, receive data about the electronic interaction, the data having been monitored in the communications network; and wherein generating the path embedding comprises using the received measurement data.

Any of the previous examples for the computing apparatus further comprising the circuitry to: use the attention network of the machine learning model, where the machine learning model has been trained using training decision paths with the defined outcome where at least one touchpoint of each training decision path has a known level of contribution to the defined outcome.

Any of the previous examples for the computing apparatus further comprising the circuitry to: trigger the action, where the action comprises instructions to control the communications network.

Any of the previous examples for the computing apparatus further comprising the circuitry to: receive telemetry data from a data centre implementing a connections networking service, the telemetry data comprising the touchpoints.

Any of the previous examples for the computing apparatus further comprising the circuitry to: select one of the touchpoints having a highest one of the touchpoint contribution values, and to trigger the action by sending instructions to isolate an electronic device or account associated with the selected touchpoint.

Any of the previous examples for the computing apparatus further comprising the circuitry to: to generate a set of calibrated values for the set of touchpoint contribution values using a calibration layer of the machine learning model, the calibration layer using a secondary mix model.

An example of a non-transitory computer-readable medium storing executable instructions, which when executed by circuitry, causes the circuitry to: generate (1302) a path embedding representing a decision path comprising a set of touchpoints to obtain a defined outcome, each touchpoint comprising an electronic interaction between electronic devices; generate (1304) an attention path embedding from the path embedding using an attention network of a machine learning model, where the machine learning model has been trained using training decision paths having the defined outcome where at least one touchpoint of each training decision path has a known level of contribution to the defined outcome, the attention path embedding comprising a set of aggregated attention weights for the set of touchpoints in the decision path; generate (1306) a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome; and provide a recommendation for a connections networking system based on the set of touchpoint contribution values.

Any of the previous examples for the computer-readable storage medium comprising instructions, which when executed by the circuitry, causes the circuitry to: generate a modified path embedding based on the path embedding using a path interpolation layer of the machine learning model, the modified path embedding comprising the set of touchpoints and an unobserved touchpoint interpolated from the set of touchpoints by the path interpolation layer; and generate the attention path embedding based on the modified path embedding using the attention network of the machine learning model.

Any of the previous examples for the computer-readable storage medium comprising instructions, which when executed by the circuitry, causes the circuitry to: generate a positional encoded path using a positional encoding layer of the machine learning model, the positional encoded path comprising position information associated with the set of touchpoints to allow for order differentiation between touchpoints in the set of touchpoints; and generate the attention path embedding based on the positional encoded path using the attention network of the machine learning model.

Any of the previous examples for the computer-readable storage medium comprising instructions, which when executed by the circuitry, causes the circuitry to: generate the set of aggregated attention weights for the set of touchpoints in the decision path using a set of self-attention structures for a multi-head model of the machine learning model, each self-attention structure to generate a set of attention weights, and an aggregation layer to aggregate each set of attention weights to form the set of aggregated attention weights.

Any of the previous examples for the computer-readable storage medium comprising instructions, which when executed by the circuitry, causes the circuitry to: generate the set of aggregated attention weights for the set of touchpoints in the decision path using a transformer model, the transformer model comprising a plurality of transformer blocks, each transformer block comprising a multi-head model comprising multiple self-attention structures, each transformer block to generate a set of attention weights, and an aggregation layer to aggregate each set of attention weights to form the set of aggregated attention weights.

Any of the previous examples for the computer-readable storage medium comprising instructions, which when executed by the circuitry, causes the circuitry to: generate a context path embedding based on the attention path embedding and a contextual embedding using a concatenation layer of the machine learning model, the contextual embedding comprising a member embedding, a company embedding, or a campaign embedding; and generate the set of touchpoint contribution values corresponding to the set of touchpoints based on the context path embedding.

What is claimed is:

1. A method, comprising:
generating a path embedding representing a decision path comprising a set of touchpoints to obtain a defined outcome, each touchpoint comprising an electronic interaction between electronic devices;
generating an attention path embedding based on the path embedding using an attention network of a machine learning model, the attention path embedding comprising a set of aggregated attention weights for the set of touchpoints in the decision path;
generating a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome; and
providing a recommendation for a connections networking system based on the set of touchpoint contribution values.

2. The method of claim 1, comprising:
generating a modified path embedding based on the path embedding using a path interpolation layer of the machine learning model, the modified path embedding comprising the set of touchpoints and an unobserved touchpoint interpolated from the set of touchpoints by the path interpolation layer; and
generating the attention path embedding based on the modified path embedding using the attention network of the machine learning model.

3. The method of claim 1, comprising:
generating a positional encoded path using a positional encoding layer of the machine learning model, the positional encoded path comprising position information associated with the set of touchpoints to allow for order differentiation between touchpoints in the set of touchpoints; and
generating the attention path embedding based on the positional encoded path using the attention network of the machine learning model.

4. The method of claim 1, comprising generating the set of aggregated attention weights for the set of touchpoints in the decision path using a set of self-attention structures for a multi-head model of the machine learning model, each self-attention structure to generate a set of attention weights, and an aggregation layer to aggregate each set of attention weights to form the set of aggregated attention weights.

5. The method of claim 1, comprising generating the set of aggregated attention weights for the set of touchpoints in the decision path using a transformer model, the transformer model comprising a plurality of transformer blocks, each transformer block comprising a multi-head model comprising multiple self-attention structures, each transformer block to generate a set of attention weights, and an aggregation layer to aggregate each set of attention weights to form the set of aggregated attention weights.

6. The method of claim 1, comprising:
generating a context path embedding based on the attention path embedding and a contextual embedding using a concatenation layer of the machine learning model, the contextual embedding comprising a member embedding, a company embedding, or a campaign embedding; and
generating the set of touchpoint contribution values corresponding to the set of touchpoints based on the context path embedding.

7. The method of claim 1, comprising generating a set of calibrated values for the set of touchpoint contribution values using a calibration layer of the machine learning model, the calibration layer using a secondary mix model.

8. A computing apparatus, comprising:
a memory component; and
circuitry coupled to the memory component, the circuitry to:
generate a path embedding representing a decision path comprising a set of touchpoints to obtain a defined outcome, each touchpoint comprising an electronic interaction between electronic devices;
generate an attention path embedding based on the path embedding using an attention network of a machine learning model, the attention path embedding comprising a set of aggregated attention weights for the set of touchpoints in the decision path;
generate a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome; and
provide a recommendation for a connections networking system based on the set of touchpoint contribution values.

9. The computing apparatus of claim 8, the circuitry to:
generate a modified path embedding based on the path embedding using a path interpolation layer of the machine learning model, the modified path embedding comprising the set of touchpoints and an unobserved touchpoint interpolated from the set of touchpoints by the path interpolation layer; and
generate the attention path embedding based on the modified path embedding using the attention network of the machine learning model.

10. The computing apparatus of claim 8, the circuitry to:
generate a positional encoded path using a positional encoding layer of the machine learning model, the positional encoded path comprising position information associated with the set of touchpoints to allow for order differentiation between touchpoints in the set of touchpoints; and
generate the attention path embedding based on the positional encoded path using the attention network of the machine learning model.

11. The computing apparatus of claim 8, the circuitry to generate the set of aggregated attention weights for the set of touchpoints in the decision path using a set of self-attention structures for a multi-head model of the machine learning model, each self-attention structure to generate a set of attention weights, and an aggregation layer to aggregate each set of attention weights to form the set of aggregated attention weights.

12. The computing apparatus of claim 8, the circuitry to generate the set of aggregated attention weights for the set of touchpoints in the decision path using a transformer model, the transformer model comprising a plurality of transformer blocks, each transformer block comprising a multi-head model comprising multiple self-attention structures, each transformer block to generate a set of attention weights, and an aggregation layer to aggregate each set of attention weights to form the set of aggregated attention weights.

13. The computing apparatus of claim 8, the circuitry to:
generate a context path embedding based on the attention path embedding and a contextual embedding using a concatenation layer of the machine learning model, the contextual embedding comprising a member embedding, a company embedding, or a campaign embedding; and
generate the set of touchpoint contribution values corresponding to the set of touchpoints based on the context path embedding.

14. The computing apparatus of claim 8, the circuitry to generate a set of calibrated values for the set of touchpoint contribution values using a calibration layer of the machine learning model, the calibration layer using a secondary mix model.

15. A non-transitory computer-readable medium storing executable instructions, which when executed by circuitry, causes the circuitry to:
generate a path embedding representing a decision path comprising a set of touchpoints to obtain a defined outcome, each touchpoint comprising an electronic interaction between electronic devices;
generate an attention path embedding based on the path embedding using an attention network of a machine learning model, the attention path embedding comprising a set of aggregated attention weights for the set of touchpoints in the decision path;
generate a set of touchpoint contribution values corresponding to the set of touchpoints based on the attention path embedding, a touchpoint contribution value from the set of touchpoint contribution values representing a level of contribution made by a touchpoint from the set of touchpoints to obtain the defined outcome; and
provide a recommendation for a connections networking system based on the set of touchpoint contribution values.

16. The computer-readable storage medium of claim 15, comprising instructions, which when executed by the circuitry, causes the circuitry to:
generate a modified path embedding based on the path embedding using a path interpolation layer of the machine learning model, the modified path embedding comprising the set of touchpoints and an unobserved touchpoint interpolated from the set of touchpoints by the path interpolation layer; and
generate the attention path embedding based on the modified path embedding using the attention network of the machine learning model.

17. The computer-readable storage medium of claim 15, comprising instructions, which when executed by the circuitry, causes the circuitry to:
generate a positional encoded path using a positional encoding layer of the machine learning model, the positional encoded path comprising position information associated with the set of touchpoints to allow for order differentiation between touchpoints in the set of touchpoints; and
generate the attention path embedding based on the positional encoded path using the attention network of the machine learning model.

18. The computer-readable storage medium of claim 15, comprising instructions, which when executed by the circuitry, causes the circuitry to generate the set of aggregated attention weights for the set of touchpoints in the decision path using a set of self-attention structures for a multi-head model of the machine learning model, each self-attention structure to generate a set of attention weights, and an aggregation layer to aggregate each set of attention weights to form the set of aggregated attention weights.

19. The computer-readable storage medium of claim 15, comprising instructions, which when executed by the circuitry, causes the circuitry to generate the set of aggregated attention weights for the set of touchpoints in the decision path using a transformer model, the transformer model comprising a plurality of transformer blocks, each transformer block comprising a multi-head model comprising multiple self-attention structures, each transformer block to generate a set of attention weights, and an aggregation layer to aggregate each set of attention weights to form the set of aggregated attention weights.

20. The computer-readable storage medium of claim 15, comprising instructions, which when executed by the circuitry, causes the circuitry to:
generate a context path embedding based on the attention path embedding and a contextual embedding using a concatenation layer of the machine learning model, the contextual embedding comprising a member embedding, a company embedding, or a campaign embedding; and
generate the set of touchpoint contribution values corresponding to the set of touchpoints based on the context path embedding.
